(19) United States
(12) Patent Application Publication
(10) Pub. No.: US 2006/0129327 A1
(43) Pub. Date: Jun. 15, 2006

(54) Ultrasensitive sensor and rapid detection of analytes

(76) Inventors: Myung L. Kim, Champaign, IL (US); Joe Ikro, Savoy, IL (US); Hoshin Park, Champaign, IL (US)

Correspondence Address: Tin-Chuen Yeung;Everest Intellectual Property Law Group, P.O. Box 708, Northbrook, IL, 60062, US

(21) Appl. No.: 11/193,311

(22) Filed: Jul. 29, 2005

Related U.S. Application Data
(60) Provisional application No. 60/592,320, filed on Jul. 29, 2004.

(51) Int. Cl. G06F 19/00; G06K 9/00

(52) U.S. Cl. 702/19; 382/128

(57) ABSTRACT

The present invention relates to systems and methods for real time, rapid detection, identification, and enumeration of a wide variety of analytes, which include but are not limited to, cells (Eukarya, Eubacteria, Archaea), microorganisms, organelles, viruses, proteins (recombinant or natural proteins), nucleic acids, prionss, and any chemical, metabolites, or biological markers. The systems and methods, which include the laser/optic/electronic units, the analytic software, the assay methods and reagents, and the high throughput automation, are particularly adapted to detection, identification, and enumeration of pathogens and non-pathogens in contaminated foods, clinical samples, and environmental samples. Other microorganisms that can be detected with the present invention include clinical pathogens, protozoa and, viruses.

### CROSS-REFERENCE TO RELATED APPLICATION

This application claims priority from provisional application Ser. No. 60/592,320 filed Jul. 29, 2004, which is incorporated herein by reference and made a part hereof.

### FEDERALLY SPONSORED RESEARCH OR DEVELOPMENT

Not Applicable.

### BACKGROUND OF THE INVENTION

1. Technical Field

The present invention relates to systems and methods for real time, rapid detection, identification, and enumeration of a wide variety of analytes, which include but are not limited to, cells (Eukarya, Eubacteria, Archaea), microorganisms, organelles, viruses, proteins (recombinant or natural proteins), nucleic acids, prions, and any chemicals, metabolic, or biological markers. The systems and methods, which include the laser/optic/electronic units, the analytic software, the assay methods and reagents, and the high throughput automation, are particularly adapted to detection, identification, and enumeration of pathogens and non-pathogens in contaminated foods, clinical samples, and environmental samples. Other microorganisms that can be detected with the present invention include clinical pathogens, protozoa and, viruses.

2. Background Art

Currently, several rapid detection methods are available for the detection of analytes such as cells (Eukarya, Eubacteria, Archaea), microorganisms, organelles, viruses, proteins (recombinant or natural proteins), nucleic acids, prions, and any chemical, metabolic, or biological markers. Examples of these methods include nucleic acid-based assays (hybridization and Polymerase Chain Reaction (PCR)) (1, 2, 17, 32), biochemical assays (16, 24), immunological assays (4, 9), physicochemical detection methods (42), electrical detection methods (35), microscopical detection methods (38), bacteriophage-based assays (14, 20), detection methods based on selective media and culturing (11, 25, 31), and optic-based assays (26). All of these currently available detection methods do not meet all the requirements of an ideal detection system due to their inherent limitations.

In PCR-based assays, including real-time PCR assays and nucleic acid hybridization assays, it is necessary to incorporate culturing steps to achieve high sensitivities (32). If a culturing step is not included, dead cells can be detected, which results in an undesirable outcome. Also, it is a complex multiple assay system which has a relatively high cost, requires well-trained personnel, and has a longer detection time than other rapid methods. The presence of various PCR inhibitors in samples or enrichment media may affect the primer binding and amplification and result in false positives/negatives (36, 39). Thus, the PCR-based tests may not be applicable to food, clinical or environment samples (2, 36).

Antibody-based assays, such as ELISA, agglutination tests, and dipstick tests, are another widely used methods. However, because of the their low sensitivity of some assays (such as dipstick tests and agglutination assays), these methods often generally require relatively long enrichment times (9). Although the ELISA's sensitivity is relatively high, it still requires a long testing time and involves laborious procedures. In addition, ELISA assays are expensive since they require expensive instrumentation and high quality purified antigens. (4).

Another antibody-based method is the immunomagnetic separation (IMS) method, which can shorten enrichment time and selectively capture bacteria by employing specific antibodies coupled to magnetic particles or beads (30, 33). IMS is used to capture and concentrate selective target organisms, proteins, or nucleic acids (14, 15). Like other antibody-based assays, IMS also requires an enrichment process and is limited for use on small volume samples (5, 7, 8, 29). IMS by itself is not a desirable assay system and needs to be modified and incorporated into a much more sensitive and user-friendly system. Indeed, IMS can be adapted for use with the present invention to generate a sensitive detection system.

Biochemical-based assays, such as bioluminescence (ATP detection), are relatively rapid as compared to many other methods. However, sometimes this method does require a long enrichment procedure to obtain a pure culture (12, 18, 28). ATP detection methods using bioluminescence have limitations in non-selectivity for pathogens, low sensitivity, and indigenous ATP interference (27). Thus it does not distinguish pathogens from prevalent non-pathogenic microflora organisms in a given environment sample (28, 37).

One of the newer technologies for rapid detection of biological particles is modified flow cytometry (FC). It is a powerful research tool that can measure specific properties of cells on an individual basis and has the capacity to sort and count cells as they pass single file through a narrow sheath orifice (10, 13, 22, 23, 41, 43). An FC-based system for detecting foodborne bacteria has been marketed previously without success by Advanced Analytical Technology, Inc (AATI) (Ames, Iowa). However, FC can encounter problems when applied to detecting bacteria cells in food-based samples. For instance, when debris from food particles or coagulated microflora larger than 0.25 mm in size are present with the target bacteria in the flow of the liquid sample, the sheath and/or orifice opening could become blocked. Not all bacteria are the same size, so the fixed sheath diameter would need to accommodate different cell sizes while at the same time allowing the cells to flow through in single file for accurate detection and counting. Such a FC-based system also requires an enrichment period of 16-36 hours to achieve high sensitivities. The vacuum tubes, sheath, and other static parts that come in contact with the bacteria require thorough washing and disinfecting after each sample, thus it is not user-friendly. In addition, since the calibration of such instrument is a time-consuming and complicated process, this system may not be suitable for untrained personnel not familiar with FC function and analysis. Furthermore, too many complicated parts can cause difficulty in trouble shooting and frequent breakdowns especially with the vacuum driven system. This instrument is also quite expensive and the machine itself is large and heavy. The cost and space requirements would make this instrument suitable only for large and well-established testing labs or organizations. Indeed, AATI has withdrawn its FC machine from the food testing market.

Fluorescence correlation spectroscopy (FCS) is another technique employed to achieve sensitive and accurate detections for biological molecules. FCS is a technique that measures fluctuation of fluorescent particles in a very small volume of sample. The fluctuation is caused by the diffusion of fluorescent particles (or fluorescent-labeled particles) in a detection volume. The defined detection volume is located within a sample and is determined by the area in which an excitation laser is focused via high aperture microscopic objectives. The emitted fluorescent signal is detected by a photon-count sensor (e.g. photomultiplier tube (PMT) or charge-coupled device (CCD)), which collects information regarding fluorescent intensity and particle number as the particles pass through the detection volume in a given period of time. Developed in the 1970's, FCS is widely utilized in the study of dynamics of fluorescent emitting particles when they are present in very low concentrations (40). More recently, it became possible to detect a single particle in a micro-liter scale sample volume with the help of the confocal microscopic setup (6, 19). This led to several applications in biologically relevant systems in which the kinetics, dynamics, and concentrations for nano-to micro-sized molecules could be studied. The variety FCS applications for the detection of microorganisms and biological molecules has been successfully demonstrated in controlled samples in conjunction with nucleic acid amplification methods and immunological methods. For example, the dynamics of fluorescence dye incorporation into a specific target molecules in bacteria, viruses, and protein aggregationes in micro-scale volumes of samples have been shown (3, 21, 34).

In spite of the high sensitivity of the FCS technique, there are clear disadvantages associated with the use of the FCS technology as a detection or diagnostic tool for crude food, environmental or clinical samples. While the best sensitivity is achieved when a homogeneous particle is present in the detection volume in reality homogeneity is very difficult to achieve in real, naturally occurring test samples such as food, environmental and clinical samples. For example, food homogenate is a complex and turbid fluid mixture containing salts, proteins, lipids, saccharides, colloidal particles, etc. The heterogeneous composition of such a sample substantially compromises the sensitivity of FCS in many different ways, such as interference by auto-fluorescence, increase in noise signal level when complexes of particles pass through the detection volume, and the physical blockage of emitted fluorescent signals from intended target molecules. Thus, FCS technology is not perfectly suitable for the detection of microorganisms and nano-scale biological molecules due to the heterogeneity of naturally occurring samples.

Another limitation of FCS lies in the volume of sample that can be measured. This system is designed to analyze samples in which a few target organisms or molecules are contained in the microliter (or less) range. However, most biological and environmental samples contain a small number of target molecules in a large volume (in the range of milliliters). In order to meet the volume requirement for FCS, intensive and time consuming steps are required to concentrate target molecules into a thousandth of original sample volume. Although it is possible to use FCS to detect target particles by measuring multiple small fractions of a larger sample volume, this time-consuming task would not be statistically reliable in the case of rare target particles that might be present in only one or two of the small fractions analyzed. This fact prevents FCS from providing rapid and real time screening or detection when a small amount of target microorganisms or molecules are found in a larger volume exceeding FCS's capacity.

FCS systems are composed of a tightly controlled and focused laser beam, a complicated confocal setup, and precise laser emitting sources, all which need to be incorporated into an instrument large enough to accommodate the necessary parts, yet designed to allow easy accessibility for the repair or replacement of components and compact enough to be convenient to the end user. The initial manufacturing of these instruments can be very expensive and subsequent necessary or desired modifications can also be costly. In addition, data analysis often must be carried out by trained personnel to ensure the proper interpretation of results. Because of these factors, current FCS instruments are less versatile and economical than the present invention that is discribed in this disclosure. Two commercial FCS instruments are currently available. One is the ConfoCor2/LSM 510 by Carl Zeiss (Germany), and the other is the ALBA by ISS (Champaign, Ill.).

As discussed above, the major drawbacks present in current methods of rapid detection of analytes, particularly biological analytes from foods, environmental and clinical sources include the requirement for an enrichment process, low detection sensitivity, the need for specialized training or personnel, and the requirement for multiple or complicated steps. Any one of these drawbacks can lead to inaccurate measurements or delays in the getting the results from one day to several days. Delays in detection and subsequent containment of foodborne or environmental pathogens and/or their byproducts can potentially cause serious medical problems to the public and economical loss for food and diagnostic industries. Recently, terrorist threats and accidental contamination in our nation's food infrastructure have caused increased safety concerns in our society.

There is clearly a need for the development of more sensitive diagnostic methodologies that can be used to rapidly detect and identify the presence of low concentrations of pathogens in food products as well as in environmental and clinical samples. The present invention is intended to overcome the drawbacks in currently available analyte detection technologies.

These and other aspects and attributes of the present invention will be discussed with reference to the following drawings and accompanying specification.

### BRIEF DESCRIPTION OF THE DRAWINGS

FIG. 1 is a schematic diagram of an exemplary instrument of the present invention.

FIG. 1A is a side view of the instrument, and FIG. 1B is a top view of the instrument;

FIG. 2A is an illustration of a hollowed out cuvette design; FIG. 2B is an illustration of a thin rectangular cuvette design;

FIG. 3 is an example of an algorithm for a software used to analyze the digitized signals in the present invention;

FIG. 4 is a schematic diagram of another embodiment of an instrument of the present invention with the light source perpendicular to and aligned with the cuvette and the objective microscope lens;

FIG. 5 is a cuvette designed for preventing sedimentation in the sample mixture during sideways and other motions;

FIG. 6 is a motion control unit for providing simultaneous vertical and rotational motions with only one motor unit;

FIG. 7 is a light image processing system for use with a thin rectangular cuvette and a photomultiplier tube (PMT);

FIG. 8 is a light image processing system for use with a thin rectangular cuvette and a capture-coupled device (CCD);

FIG. 9 shows the correlation of fluorescence signal counts vs. the number of fluorescent microspheres in phosphate buffer. Each measurement was taken for 2 min. All data are collected in different days. The fluorescent signal count is plotted according to the number of bead. The legend indicates the date of experiment and a trend line with R-square value;

FIG. 10 shows the result of detecting. S. typhimurium counts by using polyclonal antibodies conjugated with fluorescent dye in phosphate buffer. A plot of the mean counts of fluorescent signal vs CFU/ml is shown. The signal count of 1e4/ml and greater concentrations are significantly greater than that of control (ANOVA, p<0.05). High correlation between the signal counts and CFU/ml is observed in a concentration range of 10⁴ cells/ml to 10⁶ cells/ml (R²=0.9685). CFUs were determined by the MPN (most probable number) method. The data are presented in log scale. Thirteen sets of assay were performed in different times (n=13). Mean±S.E. (standard error) is shown;

FIG. 11 shows the result of the detection of S. typhimurium by using polyclonal antibodies conjugated with fluorescent dye in ground beef. A plot of the mean signal count vs CFU/ml is shown (log scale). The counts of 1e4/ml and greater concentrations are significantly different from that of control. High correlation between signal counts and CFU/ml is observed in a concentration range of 10⁴ cells/ml to 10⁶ cells/ml (R²=0.9685). CFUs were determined by MPN method. (most probable number). Four sets of assay were performed in different times (n=4). Mean±S.E. (standard error) is shown;

FIG. 12 shows the result of the detection of S. typhimurium in phosphate buffer by using fluorescent nanospheres. A plot of the amplitude of low frequency signals vs CFU/ml is shown. Amplitude of low frequency signals is evaluated by PSD function. CFU/ml was determined by MPN method. The amplitude of low frequency signals of 10⁴ cells/ml samples is significantly higher than that of control (ANOVA, p<0.01, t-test, p<0.01). The concentration of cells is presented in log scale. Three sets of assay were performed in different times (n=3). Mean±S.E. (standard error) is shown;

FIG. 13 shows the result of detection of S. typhimurium in phosphate buffer by using fluorescent beads. A plot of the mean signal count vs CFU/ml is shown. CFUs were determined by MPN method. Ten sets of assay were performed in different times (n=10). Mean±S.E. (standard error) is shown. The open triangular is the method of signal counts. The closed circle is the method of weighted counts;

FIG. 14A is the result of the detection of S. typhimurium in ground beef and FIG. 14B is the result of the detection of S. typhimurium in lettuce by using fluorescent beads. A plot of the mean signal count vs CFU/ml is shown. CFUs were determined by MPN method. Six sets of each sample were performed in different times (n=6). Mean±S.E. (standard error) is shown; and

FIG. 15 is the result of the detection of Bovine Serum Albumin (BSA) in phosphate buffer using fluorescent dye. A plot of the fluorescence hit counts vs. protein concentration/ml was counted. Each measurement was taken for 2 minutes (120 sec).

### DETAILED DESCRIPTION OF THE INVENTION

While this invention is susceptible of embodiment in many different forms, there is shown in the drawings and will be described herein in detail, specific embodiments thereof with the understanding that the present disclosure is to be considered as an exemplification of the principles of the invention and is not intended to limit the invention to the specific embodiments illustrated.

The present invention relates to systems and methods for real time, rapid detection, identification, and enumeration of a wide variety of analytes, which include but are not limited to, cells (Eukarya, Eubacteria, Archaea), microorganisms, organelles, viruses, proteins (recombinant or natural proteins), nucleic acids, prions, and any chemical, metabolic, or biological markers. The microorganisms can be pathogenic or non-pathogenic, and can be food-borne. The pathogens can also be clinical pathogens. Example of food-borne pathogens include but are not limited to Salmonella sp., Listeria sp., Campylobacte sp., Staphylococcus sp., Vibrio sp., Yersinia sp., Clostridium sp., Bacillus sp., Alicyclobacillus sp. Lactobacillus sp., Aeromonas sp., Shigella sp., Streptococcus sp, E. coli, Giardia sp., Entamoeba sp., Cryptosporidium sp., Anisakis sp., Diphyllobothrium sp., Nanophyetus sp., Eustrongylides sp., Acanthamoeba sp., and Ascaris ssp. and enteric bacteria. Examples of viruses include but are not limited to Norovirus, Rotavirus, Hepatitis virus, Herpes virus, and HIV virus, Parvovirus, and other viral agents. The protein can be a toxin, such as but is not limited to Aflatoxins, Enterotoxin, Ciguatera poisoning, Shellfish toxins, Scombroid poisoning, Tetroditoxin, Pyrrolizidine alkaloids, Mushroom toxins, Phytohaemagglutinin, and Grayanotoxin.

The systems and methods of the present invention are particularly suitable for complex samples having complicated compositions, such as but are not limited to food, clinical, and environmental samples. The various and diversified compositions of these samples may interfere with the detection in many known detection technologies.

The basic mechanics and concept of the present invention are derived and modified from two well-characterized systems, namely, the Fluorescence Correlation Spectroscopy (FCS) and Flow Cytometry (FC). The systems and methods, which include the laser/optic/electronic units, the analytic software, the methods and reagents, and high throughput automation, are particularly adapted to the detection, identification, and enumeration of pathogens and non-pathogens in contaminated food, clinical, and environmental samples. Other microorganisms that can be detected with the present invention include clinical pathogens, protozoa and viruses.

In the present invention, a target analyte (such as the cells, and microorganisms listed above) in a liquid sample suspension is mixed with an appropriate reagent to form a sample mixture. The reagent contains an appropriate fluorescent ligand which is formed by conjugating the ligand to fluorescent particles, dyes, or fluorescent beads. The ligand binds specifically to the target analyte. The fluorescent ligand fluoresces when exposed to an excitation light with an appropriate excitation wavelength. If the sample suspension contains the target analyte, the target analyte binds with the fluorescent ligand. The target analyte bound to the fluorescent ligand passes through an excitation volume (also known as the illuminated volume, scanned volume, or detection volume) and generates detectable fluorescent signals. The system counts the number of fluorescent signals or measures the amount of fluorescent signals which correspond to the number of analytes. Various signal analysis tools can be employed to measure fluorescent signals and correlate them to the quantity of analytes or identify positively or negatively the presence of the analytes of interest. The system detects, identifies, and enumerates the target analytes as a function of the number of fluorescent particles or numerical measurement of fluorescence within an excitation volume of the sample.

Ligands can be any type of molecules that can recognize and bind to complimentary target molecules. The ligand may bind to a specific component of a cell or to target epitope(s) on target proteins to form a molecular complex. In a preferred embodiment, the ligands are polyclonal or monoclonal antibodies (or a mixture thereof), which binds specifically to antigens such as a cellular component in the cell or epitope(s) on a target protein. The cellular component is generally a macromolecule, which can be a protein, a carbohydrate, nucleic acids (DNA or RNA), or a glycoprotein. The cellular component is preferably a surface molecule on the cell or microorganism. An example of a surface cellular component suitable for the present invention is membrane-bound proteins. The cellular component could also be an intracellular molecule. In another embodiment, the ligand binds to a specific nucleic acid sequence in a cell or microorganism. The nucleic acid can be DNA or RNA. In this embodiment, the ligand can be a complementary nucleic acid sequence or another molecule.

Optionally, the target analyte can be isolated, captured and/or concentrated before mixing with the fluorescent ligand reagent. In a preferred embodiment, this step can be accomplished with immunomagentic separation techniques, which will be discussed in detail below. The capturing/isolating/concentrating step can be conducted simultaneously with the mixing step.

A wide variety of samples are suitable for the present invention. Examples of such samples include but are not limited to: (a) food products potentially containing contaminating pathogens (e.g., Salmonella sp., Listeria sp., pathogenic E. coli, Campylobacter sp., Staphylococcus sp., Vibrio sp., Alicyclobacillus sp., Leptospira sp, Entamoeba sp, Noro virus, Enterogenic virus and the like, and toxin proteins (botulinum toxins, enterotoxins, aflatoxins, and the like); (b) environmental samples (e.g., from rivers, lakes, ponds, sewage, reservoirs and the like) potentially containing pathogenic microorganisms and viruses or harmful chemicals (such as herbicides, pesticides, industrial pollutants and the like); and (c) clinical samples potentially containing clinical pathogens (including but not limited to pathogenic bacteria and viruses) and biomarker proteins; and clinical samples to be tested for specific cells (e.g., cancer cells, macrophages, red blood cells, platelets, lymphocytes, stem cells etc.). Clinical samples include but are not limited to blood, plasma, and other body fluids such as sweat, saliva, cerebral fluid, spinal fluid, synovial fluid, amniotic fluid and the like.

The present invention can also be used to detect specific nucleic acid sequences with minimal amplification. For example, a specific target sequence can be detected by using magnetic beads with complementary sequences of nucleic acid sequences attached to the surface of the beads. These surface sequences would have fluorescent dyes associated with the sequences, but quenched for fluorescence through physical mechanisms of looping the sequences or through other enzymatic means. Upon binding to the target sequences in the sample, these sequences will be exposed and fluorescent dyes would be released for fluorescence emission. Other various methods to detect oligonucleotide sequences can be combined with the present invention for detection and diagnostic.

Instrument Designs

The present disclosure describes novel systems and methods for the rapid detection of a wide variety of analytes. The methods can be carried out by instruments specifically designed for the systems and methods. The instrument design is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

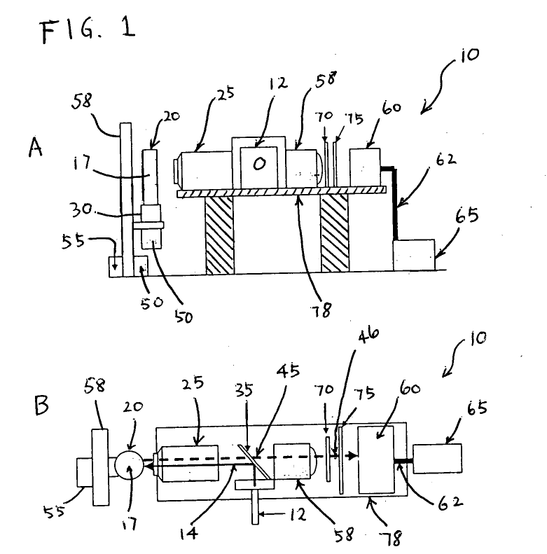

An exemplary instrument in the present invention, also known as the Real Time Analysis of Pathogen Identification and Detection (R.A.P.I.D.) System, is shown in FIGS. 1A and B. This exemplary system 10 comprises an excitation light source 12 to provide an excitation light 14 to excite the sample mixture 17 held in a cuvette 20. A cuvette holder 30 holds the cuvette 20. The sample mixture 17 contains the sample suspension which may or may not contain a target analyte and is formed by mixing the liquid sample suspension to be tested with the fluorescent ligand as described previously. Optionally, the target analyte may be isolated, captured, and/or concentrated before mixing with the fluorescent ligand.

In a preferred embodiment, the cuvette 20 is a cylindrical cuvette with a round bottom. The cuvette 20 can be made of any known transparent material suitable for a cuvette, including but is not limited to glass or other hard plastics such as polycarbonate, polystyrene and the like. Preferably, the cuvette 20 is made of polystyrene. The cuvette 20 made of polystyrene has less scattering light effects than glass. Also, it has better resistance to force than glass, and so it ensures safety for those who operate this instrument. In addition, the cost of sterilizing individual polystyrene cuvettes is cheaper than glass or other materials. The volume capacity of the cuvette 20 is preferably in the range of milliliters, and more preferably from about 1 to about 4 ml, and most preferably about 4 ml. The liquid sample mixture 17 is preferably held and capped inside the cuvette 20 to ensure that the content in the cuvette 20 does not spill out of the cuvette 20.

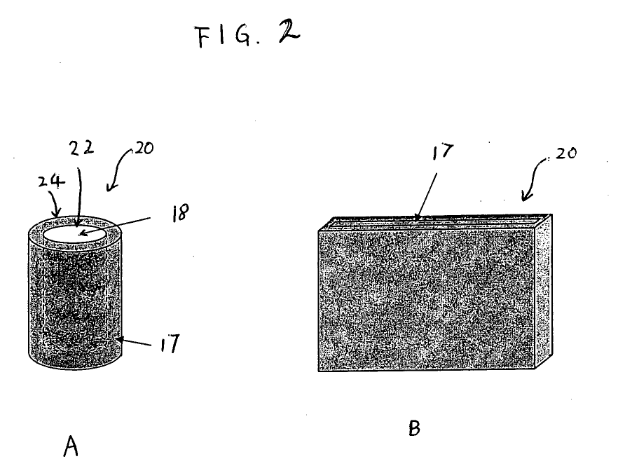

Other different cuvette shapes and designs can also be used for improved results and serving other purposes. For example, a hollowed out shape would be beneficial in the present invention (see FIG. 2A). Hollowed out cuvette is designed in a way that it contains an inner sleeve 22 within the exterior cuvette sleeve 24, with a hollow core 18 in the center of the cuvette 20, in such a way that reduces the volume of liquid contained in the cuvette. In other words, liquid sample 17 would be contained between inner sleeve 22 and outer sleeve 24 of the cuvette 20 where the center is hollowed out. The advantage of this design is to reduce the volume of sample mixture needed, which will then enhance sensitivity of measurement by increasing the analyte concentration. In another example, a cuvette with a thin rectangular shape can also be used (FIG. 2B). A cuvette is designed into a rectangular shape with shallow horizontal depth, which forms a thin film-like space inside the cuvette 20. The thin film-like feature allows small volume of sample (less than 100 microliter) to be distributed evenly. The depth of cuvette needs to be determined experimentally not only to assure that all the sample can spread evenly without trapping air, but also to arrange the focal point of excitation light in a proper position inside sample. Analytes are detected by scanning the surface of cuvette with a sensor system such as CCD or PMT. As CCD scans through the flat surface of cuvette, it takes a snap shot image of detection volume in several different locations in a sample. The collected images are processed into fluorescence signals. PMT can also scan through the surface of the cuvette by line by line motion, and fluorescence signal can be directly obtained from a sample.

In addition to the capability of handling highly concentrated microliter-scale sample volume, this design has an advantage in the reduction of noise signal. In the present system, the excitation and emission light can be deflected or scattered due to the surface curvature of present cylindrical cuvette when it is engaged in linear and vertical motions. As a result, the strength of true emitting lights can be diminished, as well as the undesirable signals can be detected by a photosensor. However, the newly designed cuvette with flat surface allows the excitation and emission lights to pass perpendicularly to the surface plane of cuvette, minimizing the production of deflection or scattering of lights at the surface of cuvette. With the reduction in the interference of noise signals, the detection sensitivity for true signal can be improved substantially. Also, these types of scanning system (line by line pattern or other linear scanning scheme) ensure to detect the signal in different locations in a sample by controlling the scan path to be unidirectional. It can prevent the same detection volume from being scanned repeatedly, which may be an inherent drawback associated with a cylindrical cuvette scanning system when proper speeds of linear and vertical motion are not applied.

Other variations on the shape of the cuvette 20 include but are not limited to shape of the bottom of the cuvette (e.g., flat bottom instead of round bottom), diameter, and other exterior and interior modifications. Other material modifications may also be needed to accommodate changes in instrument design and function. For automation and high throughput designs of the instrument, 96-well or 384-well plate variations or multi tube or cuvette cartridge design for a carousel system can be used. Another example of rectangular cuvette variation is that those cuvettes can be stacked up on the multiple cuvette holders, and laser beam can focus on one side of the cuvette.

Any excitation light source can be used to provide the excitation light 14 provided that the source can generate the light with a wavelength needed to excite the fluorescent label of the ligand. Preferably, the light source 12 is a laser, and more preferably a light emitting diode (LED) laser. A LED laser is preferred due to its compact size, low heat generation, ease of installation and mounting, ease of replacement with other wavelength lasers, lower cost, and longer life time than laser devices utilizing halogen gas (e.g. argon) without compromising the capability of exciting fluorescent particles. An example of the light source 12 is a single mode 630 nm wavelength LED laser with 7 mW or 30 mW power. Alternative choices of laser sources, such as argon gas lasers or frequency-doubled NdYAG lasers, may also be used to improve the precision of the focal point. Also, when a two photon-excitation system is adapted to increase the specificity of target detection, tunable laser source, such as the tunable titanium sapphire laser, may be used.

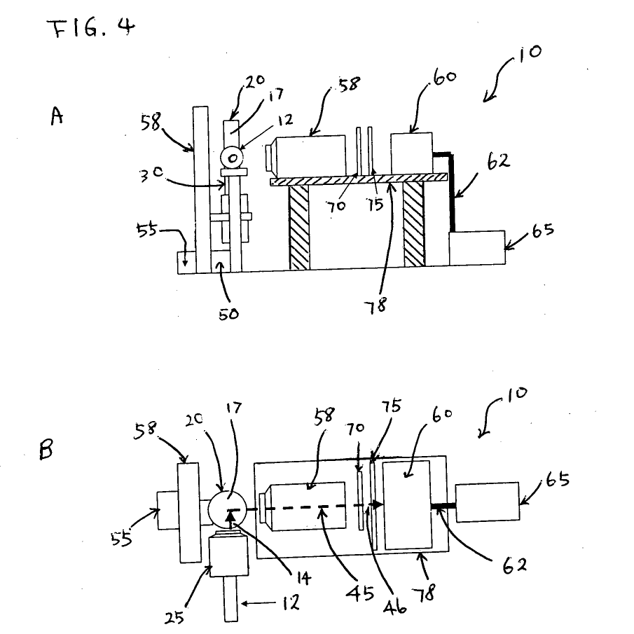

The excitation light source 12 can be positioned at any angle with reference to the cuvette 20. In a preferred embodiment, the excitation light source 12 is positioned substantially perpendicular to but not aligned with the cuvette 20 as shown in FIG. 1A and B. In another embodiment, the excitation light source 12 is positioned substantially perpendicular to and aligned with the cuvette 20 as shown in FIGS. 4A and B.

In embodiments in which the excitation light source 12 is not aligned with the cuvette 20, the excitation light 14 is deflected to the sample mixture 17 in the cuvette 20 through a dichroic mirror (also known as a dichroic filter) 35. The dichroic mirror 35 is not needed if the light source 12 is aligned with the cuvette 20. A first microscope objective lens (also known as the objective lens) 25 focuses the excitation light 14 forming a focal point at a spot inside of sample mixture 17 in the cuvette 20. The power of objective lens is preferably from about 10× to about 40×. In a preferred embodiment, the first microscopic lens 25 sets a focus at the center of cuvette 20.

A selected volume of the sample mixture 17 in the cuvette 20 is exposed to the excitation light 14. The selected volume can be a portion of the volume of the sample mixture 17 in the cuvette 20, or the entire volume of the sample mixture 17 in the cuvette 20, which may depend on the shape and design of the cuvette 20. For example, with the design of the cuvette 20 as a thin rectangular shape, the entire volume of the sample mixture 17 may be selected. It is important in the present invention that the selected volume is not exposed to the excitation light 14 more than one time to avoid counting the analyte more than one time.

Selecting a volume of the sample 17 for exposure to the excitation light 14 can be accomplished by one of several means. For example, the cuvette is moved by one or more step motors 50 to provide a motion of the cuvette 20 in one or more directions, which can be vertical, horizontal (sideway), rotational and the like, or a combination thereof. The direction of the movement of the cuvette 20 may also depend on the design of the cuvette 20. In an embodiment, the step motors are housed internally in the instrument and control the linear and rotational motion of cuvette holder 30. The motion is necessary to scan a large volume of the sample mixture 17 and to avoid scanning the same volume repeatedly. This feature allows the detection of target analytes when they are present at a small quantity in a given sample. In the embodiment in which a rectangular shape cuvette is used in conjunction with a CCD as a photo sensor, the selected volume can be decided by the position of CCD which determines the area of the cuvette is covered by the CCD.

This selected volume is known as the excitation volume, scanned volume or the illuminated volume, which is the volume within the sample mixture 17 which is exposed to the excitation light 14.

In a preferred embodiment as shown in the current exemplary system, the means for exposing a selected volume of the sample mixture 17 in the cuvette 20 to be scanned by the excitation light 14 is by providing a rotational and a slow vertical inversion motion to the cuvette 20 held in the cuvette holder 30 through a motor unit 50 attached to the cuvette holder 30. The motor unit 50 is controlled by a motor controller 55. The speed of two motions is controlled by one or two motion controller 55. In a preferred embodiment, two motor units 50 and two motion controllers 55 are internally mounted in the instrument. One motor unit is responsible for linear motions, and the other motor unit is responsible for rotational motions. The speed of linear/rotational motion, start point of scanning, duration of scanning, and scanning distance are all adjustable via a motion control software. In an embodiment, the linear speed is about 0.8 inch/sec, the rotational speed is about 300 rpm, the scanning distance is about 0.28 inch. The speed of motions and scan distance can be adjusted based on the sample volume and the concentration of target analytes. The motion of the cuvette 20 by the motor unit 50 causes the ligand-analyte complex to pass through the scanned or illuminated volume at random trajectories. The motion of the cuvette 20 allows the scanning of a large volume of the sample mixture 17 and to avoid scanning the same volume repeatedly. In particular, a linear and a rotational motion together allow the detection of target analytes when they are present at a small quantity in a given sample suspension.

Assembly of cuvette holder 30 and the motor 50 can be attached to a metal bar stand (linear actuator) 58 that moves the cuvette 20 vertically along a moving rail (not shown) on the metal bar stand 58. The main controller can be connected to the serial port of a computer via a suitable cable such as the RS232 cable.

As the analytes binding to the fluorescent ligands is exposed in the illuminated volume, fluorophores from the ligands emit energy at a wavelength unique to the fluorophore type. An emission light 45 is emitted from the sample mixture 17 if the target analyte is present in the sample suspension which binds to the fluorescent ligand in the sample mixture 17 and passes the dichroic mirror 35, if present, to travel through a second microscope lens 58 to focus the emission light 45. An emission filter 70 selectively passes only a specific range of wavelength around the peak wavelength (e.g. 640 nm filter), and the filtered emission fluorescent light 46 is sampled by a detector 60. In the embodiment in which a dichroic mirror 35 is present, the dichroic mirror may serve as the the filter for the emitted fluorescent light 45 and the emission filter 70 becomes optional. Both the dichroic filter 35 and the emission filter 57 serve to minimize interference from excitation lights and scattering lights by filtering only specific wavelength light for single or multi-photon excitation.

The filtered emission fluorescence light 46 passes through a slit (not shown) mounted on a slit holder 75. In an embodiment, a combination of two optical slit pieces is located directly in front of the detector 60. One is a vertical slit and the other is a horizontal slit made out of coated black metal, although any materials devoid of light reflection and scattering can be used. With a spacer in the middle, the two pieces are placed together to form a square shape pinhole. An important function of a pinhole is the enhancement of contrast between real signals and background noise. A pinhole tends to increase the contrast level of real signals from the background noise especially when the brightness of real signals and background noise is not substantially different from one another, which happens to occur in many biological samples. In preferred embodiments, vertical and horizontal slits of 0.005, 0.01, 0.015, 0.02, 0.025, 0.05 inches are used. The usage of different slit size is dependent on the contrast level of signals. The weaker the contrast is, the smaller pinhole is recommended for use. For antibody conjugated with fluorescent dyes, fluorescent microspheres, and fluorescent nanospheres, 0.025 inch slit pieces are suitable for proper detection. In another embodiment, the slit holder 75 has two knobs allowing one to adjust the vertical and horizontal position of the slit (or pin hole).

The filtered emission light 46 is then sampled by the detector 60 at a certain sampling rate (such as 20 to 100 K Hz) producing a multitude of signal peaks that can be graphed as a function of fluorescence intensity over time, F(t). The detector 60 is a photo sensor. In a preferred embodiment, the detector 60 is a photomultiplier tube (PMT), such as the HC120 PMT from Hamamatsu, Japan. In another embodiment, the detector 60 is an avalanche photodiode (ADP) that has higher quantum efficacy than the PMT. In yet another embodiment, the detector 60 is a Charge-Coupled Device (CCD). The choice of the photo sensor is not only dependent on its sensitivity, but it also needs to take into consideration the design of the cuvette 20 and the compatibility of the sensor to the data acquisition hardware.

The detector 60 is connected to an A/D converter 65 by an appropriate cable 62 such as the BNC cable. The A/D converter 65 converts the analog signals from the detector 60 to digital signals. Digitized signals are referred as raw data. The A/D converter 65 is connected to a data acquisition card (not shown) housed inside a main computer (not shown) via an appropriate cable (not shown) such as the 100 pin I/O cable and the like.

The digitalized signal can be analyzed by one or more of the various signal pattern recognition models such as but are not limited to power spectral density function (PSD), signal peak count method, weighted signal methods. It is the changes in the signal amplitude, pulse width, and amplitude that are evaluated by the signal process, and determined if a target analyte is present in a sample. The test result can be displayed qualitatively or quantitatively.

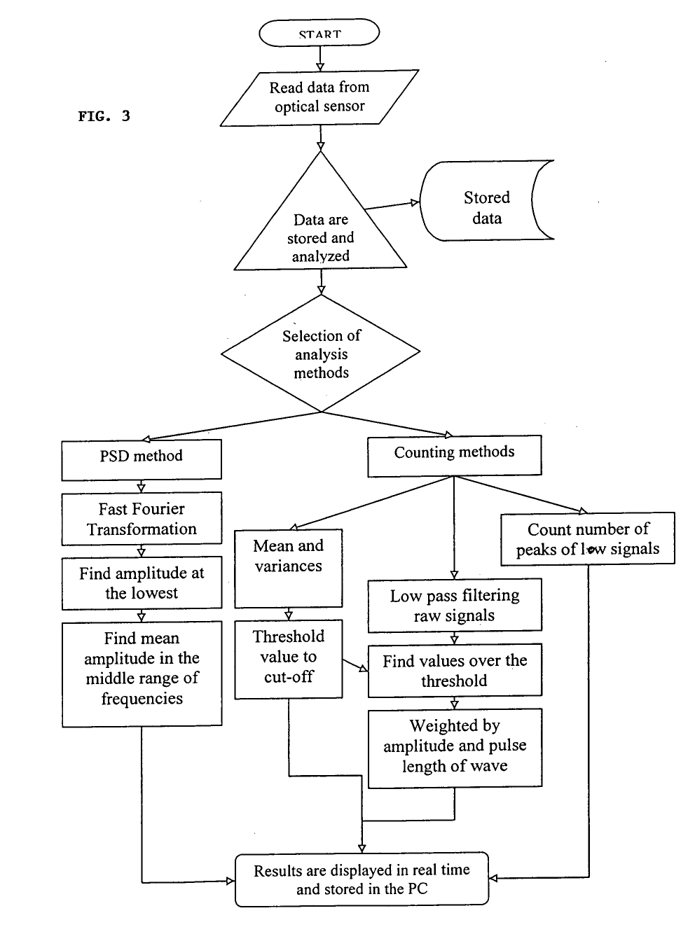

The time trace of the signal giving the photocurrent as a function of time is stored in the computer and analyzed by a software specifically developed for the instrument of the present invention. The software takes into consideration the low pass filtering scheme to avoid undesired electric and mechanical nose signals. The software can also utilize several methods to analyze the signals. The low and middle frequency signals can be analyzed by, for example, the power spectral density function (PSD). Intended target signals mostly belong to this frequency range. Also, another approach is to determine the number of signal peaks. Signal peaks are counted in when their amplitudes are greater than that of the background noises. The mean amplitude and variance of background serve as threshold amplitude to determine the positive peaks. An example of an algorithm for the software is shown schematically in FIG. 3.

Signals from the target analytes bound to the fluorescent ligands are wider in pulse width and higher in amplitude compared to those from the background. The software is designed to differentiate true signal from noise by its pulse length and amplitude. True signals weigh more than background signals when their pulse width and amplitude are considered. In a preferred embodiment, multiple levels of data analyses are performed to ensure an accurate and consistent detection of target analytes within a given sensitivity in real time. In a preferred embodiment, the raw data are analyzed by the following analytical methods, which are 1) the magnitude analysis of low and medium frequency signal by using power spectral density (PSD) function, 2) enumeration of the number of signal peak whose amplitude is greater than that of mean background, and 3) pulse or amplitude weighting method. Brief description of each analytic methods are as follows.

In the present invention, raw data is a mixture of fluorescent signals generated by target anlaytes bound to the fluorescent reagents, unbound fluorescent reagents, light reflected or scattered light noise, and electrical/mechanical signal interference and others. Thus, there is a need for data analysis methods that are capable of distinguishing the intended fluorescent signals from all other noise signals. PSD function is one of such analytic methods. PSD function deconstructs the raw fluorescence signals into segmented blocks of specific signal patterns. Each block of signals is composed of similar amplitude and frequency patterns obtained from the raw signals. Those amplitude and frequency data are combined together within the block of signal pattern to generate another level of signal patterns that are labeled and assigned as low, medium, and high signal frequency range. Low and medium frequency range in the final form of PSD signals are mostly true signals where majority of noise signals are excluded. Thus, by using PSD function, fluorescent signals generated from target analytes can be differentiated from noise signals. This merit of the PSD function allows the evaluation of changes in amplitude/frequency of signal with minimal interference of noise signal when the target organisms are present in a given sample. PSD is indeed a well known algorithm system. However, the usage of this PSD according to a specific instrument and reagent system can be customized and thus a unique feature in data analysis program.

Another way to eliminate unwanted noise signal is to use low pass filter. The low pass filter blocks significant amounts of noise signals occurred at high frequencies, but passes signal at lower frequencies for analysis. There are two types of low pass filters; analogue circuit type and digital circuit type. Although the digital circuit type low pass filter is preferred, both types are compatible with the system of the present invention.

The filtered raw data is then subjected to the signal enumeration analysis by counting all signal peaks that have greater amplitude than cut-off amplitude, which is referred to as a threshold. To obtain a proper threshold value, unfiltered data is analyzed that include a large number of noise signals. The mean and variance (standard deviation) of the unfiltered data are set as threshold values. A degree of variance applied to the analysis is dependent on the reagent types used due to different signal strengths. For example, threshold of mean plus 1.5 times of variance is applied to analyze the data collected from the fluorescent dye particle reagent system, and mean plus 3 times variance is used as a threshold to analyze the data collected from the fluorescent microsphere reagent system.

When target analytes are present at a very low concentration in a sample, the result from peak count method does not seem to be clearly different from background. The count method is incapable of discriminating background signals from desired or true signals. Rather, it counts any peaks whose amplitude is greater than the threshold. As a result, when target anlaytes such as microorganisms are very small in quantities in a given sample, the count result tends to be inaccurate. In these cases, a weighted method is designed to further repress the interference of noise signals and to improve the sensitivity of the detection system. Weighted method utilizes the amplitude and pulse width of a signal peak. The amplitude is dependent on the intensity, and the pulse width is determined by measuring the time duration for a signal peak to rise and fall above the threshold amplitude. In this analysis, an individual signal peak, that is greater than the threshold, is multiplied by its own pulse width or amplitude. Then, all the values are added up, which is referred to as a weighted value.

This method is based on unique characteristics of signals generated by the current fluorescent reagents. Signal generated by a target analyte bound to the present fluorescent reagent has longer duration and greater amplitudes than the signals from unbound fluorescent reagents as well as other noise due to different size and dwelling time in a detection volume. Considering this fact, it is expected that the weighted value of our desired or true signal is substantially greater than that of the background signals. Thus, the difference of the desired signals from background (signal from unbound fluorescent reagent) becomes clear even when the amount of target anlaytes are rare in a sample. Combinatorial usage of count method with weighting analysis allows achievement of a great sensitivity of the system in the present invention.

In preferred embodiments of the present invention as shown in FIGS. 1A and B and FIGS. 4A and B, all optical devices are aligned on a metal stabilizer 78. All the components in the instrument can be covered with a light-proof aluminum case to prevent interference of scattering light from entering the photo sensor 60. In another embodiment, the slit holder 75 has two small knobs allowing to adjust vertical and horizontal position of the slit or pinhole. All internal components can be covered with a light-proof case which is insulated with sound-proof material to reduce mechanical noise.

In another embodiment, shown in FIGS. 4A and B, the configuration is similar to that of the embodiment shown in FIGS. 1A and B, except that the first microscopic lens 25 and the excitation light source 12 are relocated so that first microscopic lens 25 and the light source 12 are both now at about 90° to the cuvette 20 with the light source 12 positioned directly behind the microscopic lens 25 such that all these three components (the light source 12, the first microscopic lens 25, and the cuvette 20) are aligned in a substantially straight line and the excitation light 14 from the light source 12 is focused by the first microscopic lens 25 into the sample mixture 17 held in the cuvette 20. The dichroic mirror 35 is removed since it is no longer needed to deflect the excitation light 14 from the light source 12 to the sample mixture 17.

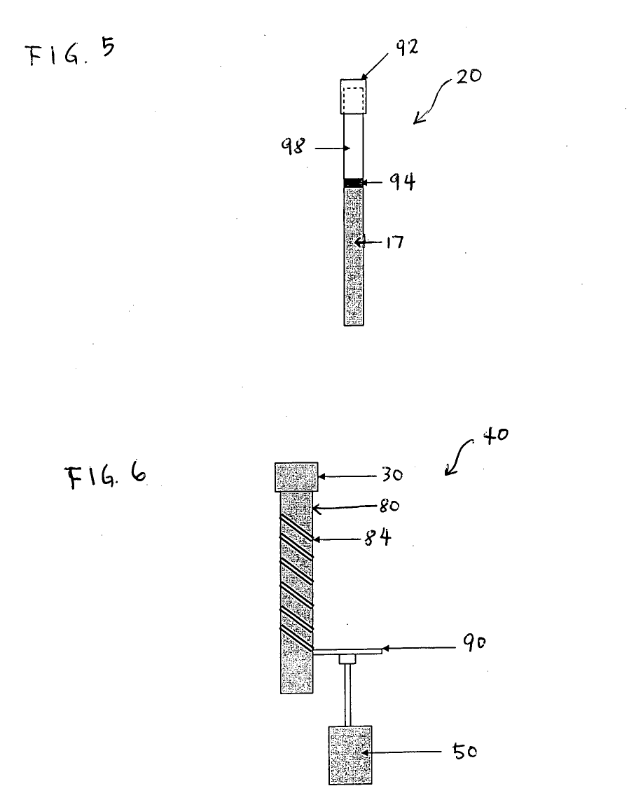

In another embodiment, the illuminated volume of the sample mixture 17 can be maximized through a special motion of the cuvette 20. The larger the illuminated volume, the higher number of target analyte molecules can be included in the scan resulting in lower detection limit of the target analyte and higher accuracy and consistency of the quantification of the analyte. In one embodiment, the special motion involves rotating the cuvette 20 while it is engaged in repeating vertical motions. The motion is driven by two separate step motors that are coordinated by two separate programmable motion controllers. One step motor is responsible for the rotation while the other step motor is responsible for the vertical motion. In another embodiment shown in FIGS. 5 and 6, the vertical and rotational motions are both driven by one motor 50 that is attached to a gear 90. The cuvette holder 30 holds the cuvette (not shown in FIG. 6) vertically and is positioned on the top of a screwed rod 80. The rod 80 is engraved with a spiral groove 84 where the gear 90 is engaged in. When the motor 50 and attached gear head 90 rotate, the gear head 90 moves along the spiral groove 84 and drives the rod 80 vertically while the rod 80 is spinning. The reverse direction in the vertical motion is performed by switching the direction of gear spin. The one-motor motion system in this embodiment is advantageous over the two-motor system in lower manufacturing cost, smaller machine size, easier assembly and replacement of unit, less in mechanical vibration and noise, and less complicated design for the motion controller software.

As detection time gets longer, the sedimentation of particles, if present in the sample mixture 17, can occur on the bottom of cuvette 20 that can impair detection accuracy, consistency, and sensitivity of present system. To prevent the sedimentation of particles in the sample mixture 17, the sideway displacement or motion of the cuvette 20 can also be considered in conjunction with using a cuvette 20 as shown in FIG. 5 which is equipped with a back flow stopper 94 such that little or no air is trapped between the sample mixture 17 and the back flow stopper 94 when the sample mixture 17 is being filled into the cuvette 20. Air 98 is present only above the back flow stopper 94 separated from the sample mixture 17. When a cuvette without a back flow stopper is laid sideways and subject to fast linear motions, turbulent flow of liquid can be caused when air is trapped inside the cuvette 20 above the sample mixture 17. The backflow stopper 94 in this embodiment inserted into the cuvette 20 prevents air from trapping inside the cuvette 20 above the sample mixture 17 and prevents the turbulent flow and subsequent sedimentation of any particles in the sample mixture 17. The cuvette 20 shown in FIG. 5 can also be used to prevent sedimentation with other types of motion other than the sideways motion.

One of the advantages of the present invention is the high level of flexibility in detecting cells, proteins, and metabolites as well as quantifying these biological analytes. As discussed previously, the cuvette 20 can be in the shape of a thin rectangular body (FIG. 2B). This rectangular cuvette is suitable for the above mentioned biological analytes. Use of the cylindrical cuvette along with rotational and vertical movements may result in repeated measurements of the same target as there is no tagged information of analytes. Light detection scanning methods can increase accuracy of detection by reducing repeated measurements. Two different types of scans can be achieved, one with the PMT sensor (or similar sensor systems) and the other with the Charge-Coupled Device (CCD). Both types of scanning would require the use of a thin square or rectangular cuvette in place of a cylindrical cuvette. Thin rectangular cuvettes holds smaller volumes than the cylindrical cuvette (microliter ranges as compared to milliliter ranges), and thus increases the apparent concentration of the liquid sample via lower volumes. In addition, thin rectangular cuvettes can spread liquid sample over a wide area, which results in more uniform distribution of target analytes with a consistent concentration.

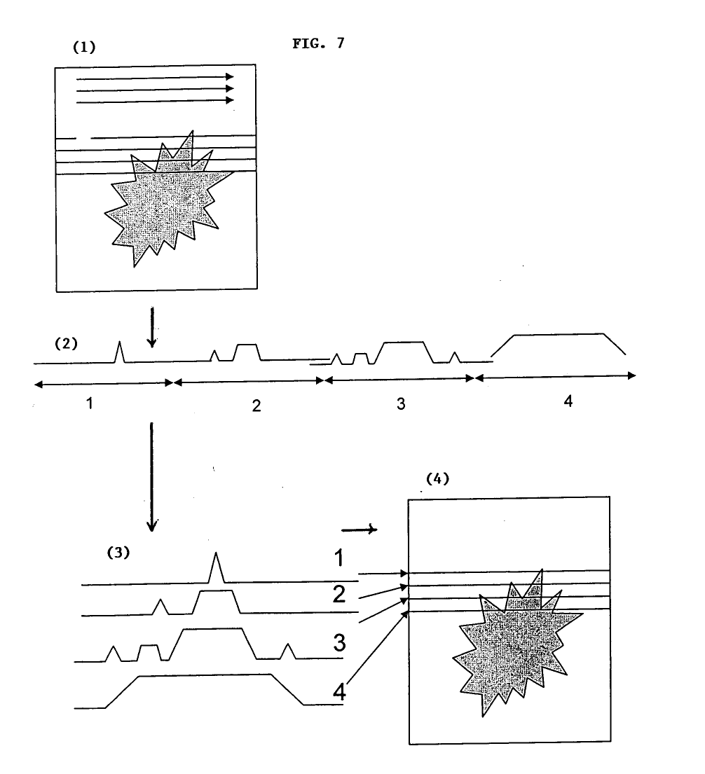

When the cylindrical cuvette is replaced with a thin rectangular cuvette and a PMT is used for scanning the emission fluorescent signals, some of the components of the system need also to be replaced. For example, rotary motion is replaced by sideways motion with a rail, and the cuvette holder is adapted for the rectangular shape instead of a cylindrical cuvette. The PMT scanning of the fluorescent signal would have to be modified as well. As shown in FIG. 7, the PMT in this embodiment scans the surface of the thin rectangular cuvette line by line driven by the rail system and the step motor (Step 1) to generate stream signals from the PMT (Step 2). Two specific functions can be achieved from this PMT scanning. First, based on fluorescence emission data, the PMT can indicate the presence of target signals. Software design can calculate the positioning of target signals based on the PMT scan speed in sideway and up and down motion. This also reduces the possibility of counting the same target more than once, hence increasing detection sensitivities and accuracies. Second, streaming signal data from the PMT can be reconstructed from two-dimension signal arrays into an image of target shape as shown in Step 3 in FIG. 7. Even though the PMT produces the streaming electric signals in Step 2, sampling time of the PMT over a given target analyte such as a cell can provide valuable information. For instance, combined with an algorithmic calculation of the motion speed of the cuvette being scanned, streaming electric signals of the PMT can generate a positioning map of the target analyte (e.g., a cell) in a given area of sample and also peripheral images of the target analyte itself as shown in Step 4 in FIG. 7. As a result, data analysis can provide the size and location of the target analyte. Also, the amplitude of the electric signal gives the strength of fluorescence and this delivers the distribution information of fluorescence over the cells, in case the type of target is a cell.

As discussed previously, a CCD photo sensor can also be used in conjunction with the thin rectangular cuvette design shown in FIG. 2B. The advantage of the CCD as compared to the PMT as a sensor is that CCD does not need to scan as it takes the snap shot of the fluorescence signal in a given area if that area is small enough for the camera to handle. When light or fluorescence emission from the target source activates the CCD pixels, the signals from each pixel of the CCD produces information on the location and size of the analyte. Differential intensity of such light emission can also generate images of target analyte distribution. The other advantage of the CCD is in detecting signals already in two-dimensions, which can provide a location of the target analyte and eliminate repeated measurement of the same target.

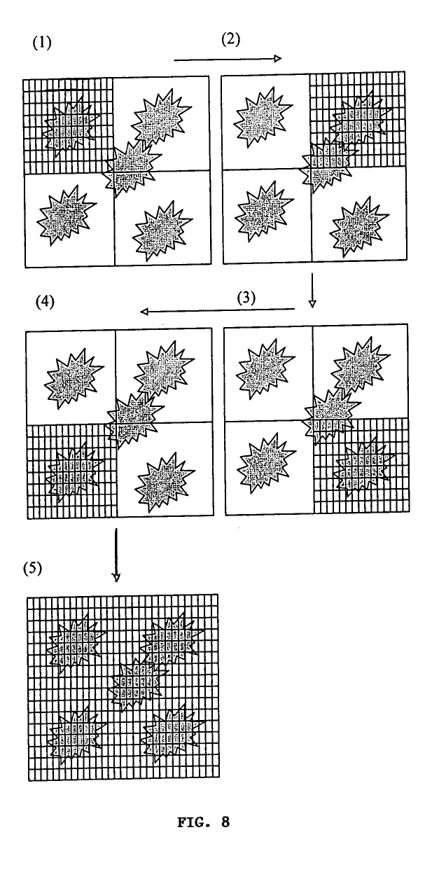

The CCD can be mounted and operated in one of several ways. For example, if the sampling size (rectangular surface size) is small enough for the CCD capacity of image, then it can be in a fixed position and does not have to scan to obtain the desired data results. When users need to measure a large volume of samples, or the size of cells or target is too small and hence need to increase resolution, the scanning method can be used with the CCD. In this case, the CCD camera scans the surface of the rectangular cuvette as in the case of the PMT scanning method. After the necessary scans, the individual scan images can be reconstructed to generate desired data. For example as shown in FIG. 8, the area of cuvette surface can be divided into several sub areas (e.g., 4×4 or 12×12) and the CCD can read each sub area one at a time (Steps 1 to 4) and then the images of each of the sub areas are merged to construct the whole picture of the scanned area (Step 5).

Reagents and Methods

High quality reagents and precise methods have been developed to achieve the best sensitivity, specificity and consistency of present detection systems for detecting and quantifying target analytes, in particular the biological analytes such as cells, microorganisms, proteins and nucleic acids or nucleic acid sequences, and in particular for complex samples such as food, environmental and clinical samples wherein the target analytes are within a very complex matrix having very complex and highly varied compositions which in many cases interfere with the detection methods.

In general, the detection methods of the present invention for these complex biological samples consist of the following key steps: (1) capturing/isolating/concentrating, (2) fluorescence labeling, and (3) detecting of target analytes.

The first step is to capture, isolate and/or concentrate the target analytes from crude samples after sample processing by using proper reagents and apparatuses. There are numerous methods to capture, isolate and concentrate anlaytes in a sample and are well known to those skilled in the art. Examples of such methods include but are not limited to various chromatographic techniques (e.g., size exclusion chromatography, adsorption chromatography, thin layer chromatography, pH gradient chromatography, salt gradient chromatography, high performance liquid chromatography, ligand-binding chromatography and the like), filtering, centrifugation, electrophoresis, isoelectrofocusing, dialysis, lyophylization, immunoseparation, immunomagnetic separation and the like. In a preferred embodiment, immunomagnetic separation technique is employed in this step to meet the following criteria: specific capture of target analytes from impure or complex biological samples, and concentration of analytes into a small volume for easier processing. This step is carried out with Reagent A and a magnetic retriever. Reagent A is a solution containing magnetic particles (e.g., microspheres) conjugated with an appropriate ligand that is capable of binding to the analyte to be detected to form a ligand-magnetic particle complex. Examples of an appropriate ligand include but are not limited to poly/monoclonal antibodies, soluble receptors or oligonucleotide probes in a liquid medium, such as a buffer (e.g., phosphate buffer) with optional detergent(s) and blocking agent(s) to prevent the aggregation of the microspheres. Although the term “immunomagnetic separation” is used here, it does not imply that the ligand has to be exclusively an immuno molecule as an antibody. As discussed earlier, the ligand can also include other suitable ligands such as but are not limited to soluble receptors and oligonucleotide probes. The magnetic microspheres are usually polystyrene beads encapsulating iron oxide and are available in different sizes (for example, size range of from 0.01 μm to 4.8 μm in diameter) and different surface properties. The choice of bead size and surface properties depend on various factors such as the type of analyte and the ligand to be conjugated on the beads. In an embodiment of the present invention, the size of magnetic microspheres is about 0.86 μm in diameter. Methods for conjugating the liquid to the magnetic microspheres are well documented and are well known to those skilled in the art. A magnet retriever physically separates the ligand-magnetic particle complex from the rest of the sample that may contain undesirable matter interfering with the detection of target analytes. The magnet retriever can be designed into various shapes with different strengths of magnetic force depending on specific applications. When the sample is mixed with Reagent A, the target analyte in the sample forms an analyte-ligand-magnetic particle complex. This complex is then separated from the sample with the magnetic retriever. Overall, proprietary reagents and apparatuses customized for specific analytes have been or can be developed to allow inexpensive, easy, less error prone, and rapid sample preparations as compared to conventional methods.

The second step is the labeling of the isolated target analytes from the first step with florescence. This process can be achieved, for example, by incubating the analyte-ligand-magnetic particle complexes obtained form the first step with Reagent B containing fluorescent particles (which can be inorganic or organic fluorophores which include but are not limited to fluorescent dyes and fluorescent beads, spheres, or other types of fluorescing molecules) that are formed by conjugating the fluorescent particle with an appropriate ligand such as but is not limited to poly/monoclonal antibody or nucleic acid probe to form a sample mixture containing the analyte-ligand-magnetic particle complexes and the ligand-fluorescent particle complexes. Methods for conjugating the ligands to the fluorescent particles are well documented and are well known to those skilled in the art. These ligand-fluorescent particle complexes in Reagent B bind to target analytes in the analyte-ligand-magnetic particle complexes through, for example, specific antigen-antibody reactions or nucleic acid hybridizations, depending on the type of ligands conjugated to the fluorescent particles, to form the fluorescent labeled analyte complexes. The first step and the second step can be combined in a single step by adding both Reagent A and Reagent B to the sample in the liquid medium simultaneously followed by subjecting the mixture to a magnetic force.

Although the size of ligand-fluorescent particle complex when the fluorescent particles are made from fluorescent dyes grants maximal access to the target analytes on the surface of the magnetic ligand complex, the low quantum yield and fast decay of fluorescence from this complex can cause poor sensitivity and inconsistency in detection results.

Fluorescent spheres (micro- or nano scale size) are preferred fluorescent particles for use in Reagent B in the present invention. This reagent is used to overcome the drawbacks that fluorescent dye particles have as mentioned above. A fluorescent sphere has greater quantum yield than a fluorescent dye particle, because a large number of fluorophores can be encapsulated in a polystyrene bead. Thus, when target analytes bound to fluorescent micro/nanospheres conjugated to appropriate ligands are excited by light source in the illuminated volume, stronger fluorescent signals are emitted. As a result, signal to noise ratio is improved when there is low level of background emission light in the sample mixture, which can be achieved by a series of washing steps.

Nano scale size quantum dot can also be used as the fluorescent particle in Reagent B. This nanoparticle has a greater quantum yield than a fluorescent micro/nanosphere and long term photostability. Also, their Stokes Shift (wavelength difference between excitation and emission spectrum maxima) are far apart, which is advantageous for fluorescence measurements. For example, one of quantum dot nanospheres is excited at 480 nm wavelength and emits signal at 640 nm wavelength. These properties of the quantum dot allow minimization of the interference of excitation light on detecting true emission light generated from target analytes, while the intensity of true signal is significantly enhanced. Together with the advantages of nano-scale size, the usage of quantum dot conjugated with appropriate ligands would substantially enhance signal to noise ratios, resulting in the improvement of sensitivity of the present detection systems.

Washing is essential in increasing the signal to noise ratio before proceeding to the third major step of detecting the emitted fluorescent signals from the fluorescent labeled target analytes. Washing time and numbers have to be experimentally determined depending on the particle size of the fluorescent particles and sample types. The washing steps can be manual, as shown in the examples disclosed in the present invention, or can be performed high throughput automated systems that employ consistent, accurate, and reliable liquid handling capability for proper washing, which would result in consistent and increased sensitivity of the present detection systems. The washed sample mixture is now ready to proceed to the next step.

The third and last major step is to measure the fluorescent signals emitted from the fluorescent labeled target analytes prepared in the second step. The washed sample mixture is placed in the cuvette 20 placed in the cuvette holder 30 of an instrument of the present invention as described above. The filtered emitted fluorescent light 46 is detected and measured. The fluorescent light travels through a series of optical devices as described earlier and is converted into electrical signals that are analyzed by a data analysis software in real time. In an embodiment, the emitted fluorescent light is measured for from about 30 seconds to about 2 minutes, depending on the volume of the sample mixture in the cuvette 20. The operation of an instrument in the present invention described above is simply to place the cuvette 20 in the cuvette holder 30, followed by hitting a start button to begin the measurement. The motion controlling/data acquisition software automatically stops the operation when a pre-set measurement time ends followed by displaying of the results. In an embodiment, the software is operating from a computer which is a separate unit from the instrument. In a preferred embodiment, the software can be operated from a central processing unit incorporated into the instrument. The high sensitivity of the instrument and its various embodiments in the present invention can provide accurate results within 2 min with minimal manual labor.

The above described analyte detection method can be modified and customized for the adaptation of detection of various analytes in various types of samples, which will be discussed in detail as follows.

Detection of Pathogenic Microorganisms in Food, Clinical, and Environmental Samples.

(A) IMS/Fluorescent Microsphere Method

This method uses a combination of immunomagnetic separation (IMS) employing ligand-magnetic microspheres in Reagent A and fluorescent labeling employing fluorescent microspheres in Reagent B. In a preferred embodiment, Reagent A contains magnetic microspheres coated with an appropriate ligand described earlier. The size of the magnetic microspheres may vary, for example, from 0.86 um to 4 um in diameter. The choice of the size of the microspheres depends on the nature of the sample to be tested. For example, if a sample has high viscosity and turbidity, a larger size magnetic microsphere (for example, between 2.8 to 4 um) is preferred for high recovery ratios of target organisms. On the other hand, if a sample is a less viscous and a clearer solution, smaller microspheres such as 0.86 um is sufficient for proper recovery.

Various methods can be used to prepare Reagent A and Reagent B for this particular or other applications. An exemplary method is described in detail as follows.

Streptavidin coated microsphere encapsulated magnetic beads are conjugated to biotinylated polyclonal antibodies via streptavidin/biotin binding. An aliquot of steptavidin coated magnetic microspheres is incubated with biotinylated polyclonal antibody for about 30 min at room temperature with gentle end-over-end rotation motions. The reaction solution is placed into a magnetic bead retriever for 3 min followed by decant of the solution and addition of a washing buffer (0.1 M phosphate buffer saline (PBS), pH 7.4, with Tween-20). This step is repeated twice. The resulting pellet is resuspended and stored with a storage buffer. The storage buffer in this example consists of 0.1M phosphate buffer saline (PBS), pH 7.4, with Tween-20, BSA, and proclin at an appropriate concentration. The Tween-20 and BSA help to prevent microspheres from clumping by blocking non-specific bindings of the microspheres. Procline is a broad spectrum anti-microbial agent and can be added at a concentration which depends on the desired shelf life of the reagent. The reagent is sonicated before use.

Reagent B contains fluorescent microspheres coated with polyclonal antibodies. The size range of this particle is from about 1 μm to about 4 μm in diameter. The excitation wavelength (Ex) range can be from about 400 nm to about 700 nm, and emission wavelength (Em) range can be from 400 nm to about 700 nm. The choice of Ex/Em wavelength ranges is dependent on the optical emission filter 70 installed in the instrument used. In this particular example, the optical device is selected to detect 640 nm (Em) fluorescent light. The condition of the sample mixture also can affect the choice of the fluorescent microspheres in terms of Ex/Em spectrum. For example, fluorescent microspheres with above 540 nm (Em) is preferred for blood containing samples to avoid interference with autofluorescence generated from endogenous fluorescent particles in the sample.

The conjugation of polyclonal antibody to fluorescent microsphere is carried out via covalent bonds between carboxyl (—COOH) group on the surface of microspheres and the amine group of the antibody via ester intermediates. This reaction is mediated by adding carbodiimide to activate the carboxyl group. Preferably, EDAC (Ethyl 3-(3-Dimethyl Amino Propyl Carbodiimide) is used to activate the carboxyl group on the surface of fluorescent microsphere. The polyclonal antibody is incubated with the COOH— activated fluorescent microspheres for about 30 minutes at room temperature followed by centrifugation at 8000 rpm to wash any unbound antibody. The result pellet is resuspended and stored with 10 mM Tris, 0.05% bovine serum albumin (BSA), and 0.05% Tween-20. The reagent is sonicated before use.

Properly sonicated Reagent A and Reagent B are added simultaneously into an aliquot of the sample for testing to form a crude sample mixture, which is followed by an approximately 30-minute incubation at room temperature with gentle end-over rotation motions. The crude sample mixture is placed into a magnetic bead retriever for about 3 min followed by decant of the solution and addition of a washing buffer. This washing step is repeated twice. The pellet is resuspended into buffer to form the sample mixture which can then be transferred to the cuvette 20. The above procedure can also take place in the cuvette 20. The cuvette 20 is preferably closed with a cap before being placed in the cuvette holder 30 in the instrument. The measurement of the emitted fluorescent light is taken for about 30 sec at room temperature.

(B) IMS/Fluorescent Dye Method

This method uses a combination of immunogenic separation (IMS) employing magnetic microspheres in Reagent A and fluorescent labeling employing fluorescent dyes in Reagent B. Reagents A is the same reagent used in the method of immunogenic separation IMS/Fluorescent Microsphere Method just described above. Reagent B is polyclonal or monoclonal antibodies conjugated to fluorescent dye molecules instead of fluorescent microspheres. In this example, AlexaFluor™ (Molecular Probes, Eugene, Oreg.) is the fluorescent dye particle. AlexaFluor™ has Ex/Em range of 633/647 nm. The choice of dye is based on our instrument's optic devices. Different AlexaFluore™ with different Ex/Em range can also be used with the modification in optic filters.

AlexaFluor™ is activated just before use by adding dimethyl sulfoxide (DMSO) to the dye. The activated dye is slowly added into antibody dissolved in sodium bicarbonate buffer with stirring. The mixture is incubated for an hour at room temperature with continuous stirring. The conjugates are separated from unbound free dye via centrifugation with a combination of membrane filtration. The resulting conjugates are stored with PBS buffer containing sodium azide at 4° C.

An aliquot of a sample to be tested is incubated with reagent A at room temperature for about 20 min. A magnetic bead retriever is applied to the sample for about 3 min to isolate target analytes followed by washing with fresh buffer twice. The solution is decanted, and the pellet is resuspended with wash buffer. Reagent B is added and incubated for about 30 min at room temperature with gentle end-over rotation. The magnetic fluorescence labeled ligand complexes in the samples are placed in the magnetic bead retriever for about 3 minutes and the washing step is repeated twice. The resulting pellet is resuspended in a buffer and transferred to a cuvette 20. The cuvette 20 is placed into the cuvette holder 30 in the instrument. The measurement of the emission light is taken for about 30 sec at room temperature.

(C) IMS/Fluorescent Nanosphere Method

The method of IMS/Nanospheres uses a combination of three different reagents (Reagents A, B, and C). Reagent A is the same reagent used in the two previous methods described in this section. Reagent B contains biotinylated polyclonal/monoclonal antibodies. Reagent B binds to the surface of the target microorganism via the antibody's active sites specific for antigen recognition. Antibodies in Reagent B also bind to the fluorescent nanospheres through interaction between the biotinylated Fc portion of antibodies and the streptavidin coated nanospheres. Reagent C contains fluorescent nanospheres conjugated with streptavidin. The size of nanosphere ranges from about 20 nm to about 200 nm. The Ex/Em range is between 400 nm and 700 nm. The conjugation of streptavidin to the fluorescent nanospheres is carried out via covalent bonding of the carboxyl (COOH) group on the surface of the microspheres to the amine group of streptavidin via ester intermediates. This can be done by adding carbodiimide to activate the carboxyl group followed by incubation with streptavidin protein. Unbound streptavidin is removed by dialysis.

In an embodiment, EDAC (Ethyl 3-(3-Dimethyl Amino Propyl Carbodiimide) is used to activate the carboxyl group on the surface of the fluorescent nanospheres. The streptavidin is incubated with the activated nanospheres for about 30 minutes or longer at room temperature followed by dialysis to remove unbound antibodies. The molecular weight cut off of the dialysis membrane is in the range of about 300 to about 500 kDa. The conjugates are stored with 10 mM Tris, 0.05% BSA, 0.05% Tween-20. Reagent C can be also applied to quantum dot conjugated with streptavidin. Quantum dot has CdSe-ZnS core and its size ranges from 10 nm to 100 nm in diameter. Quantum dot with Ex/Em ranges compatible to the optic devices is employed. Conjugation method is similar to above described procedure.

An aliquot of the sample to be tested is incubated with reagent A and reagent B at room temperature for about 30 minutes. A magnetic bead retriever is applied to the sample for about 3 minutes to isolate the target anlaytes followed by washing with fresh buffer twice. The solution is decanted and the pellet is resuspened with fresh buffer. Reagent C is added and incubated for about 30 minutes or less at room temperature with gentle rocking motions. The samples are placed in the magnetic bead retriever for about 3 minutes and the washing step is repeated twice. The resulting pellet is resuspended in a buffer and transferred to a cuvette 20. The above procedure can also take place in the cuvette. The cuvette 20 is the placed into cuvette holder 30 in the instrument. The measurement of the emitted light is taken for about 30 seconds or more at room temperature.

Aforementioned methods and reagents can also be utilized in the multiplex detection of pathogenic microorganisms in food, clinical, and environmental samples. The modifications in procedural sequence are as follows. Instead of using a single type of magnetic microsphere targeting one analyte, a mixture of magnetic microspheres conjugated to different antibodies or nucleic acid probes is incubated with a sample to be tested to extract multiple target analytes. The composition of each reagent in the mixture needs to be optimized to ensure high recovery efficiency for each targeted analyte. Magnetic bead retrieving and washing procedures remain the same as described above. The washed sample is incubated with a mixture of the aforementioned fluorescent reagents (fluorescent dye particle or micro- or nanospheres) conjugated to different antibodies or nucleic acid probes. Each reagent carries a distinctive emission spectrum, which allows the identification of different analytes in the sample. To separate multiple emitting fluorescent lights from the sample, multiple emission filters and multiple photon sensors need to be installed in the instrument.

Detection of Total Viable Cell Count or Specific Organisms

The following method is developed to detect and enumerate the total viable organisms (TVO) or specific organisms found in food, clinical or environmental samples.

To detect and enumerate total viable organisms, two different reagents (Reagents A and B) are used in this method. Reagent A contains a fluorescent dye that penetrates all organisms and stains their nucleic acids. Examples of a suitable fluorescent dye for this purpose includes but are not limited to SYTO fluorescent dyes (Molecular Probes, Eugene, Oreg.) and equivalent dyes depending on the specific application. Reagent B contains a fluorescent dye that labels nucleic acids of only dead organisms. Examples of suitable fluorescent dyes for this purpose include but are not limited to SYTOX fluorescent dyes (Molecular Probes, Eugene, Oreg.) and equivalent dyes. An aliquot of the sample is incubated first with reagent A that penetrates membranes of all microorganisms and stains their nucleic acids at room temperature. After a brief wash step, reagent B is added and incubated at room temperature, which specifically stains the nucleic acids of dead organisms. The stained organisms are then transferred to the cuvette 20. The cuvette 20 is placed into the cuvette holder 30 in the instrument, preferably with the cuvette 20 closed by a lid on the cuvette 20. Alternatively, the reaction can take place in the cuvette 20 in which the transfer step to the cuvette becomes unnecessary. The measurement of the emitted light is taken for about 2 minutes at room temperature. From population analysis of dead versus live organisms, total viable organism counts can be achieved.

Detection of Specific Organisms by Target Nucleic Acid Sequences

This method of the detecting specific organisms employed one reagent which contains magnetic microspheres conjugated with organism-specific oligonucleotides from 16S rDNA, 18S rDNA, or a specific gene. A specific target sequence can be detected by using magnetic beads with complementary sequences of nucleic acids attached to the surface of the beads. These surface sequences would have fluorescent dyes associated with the sequences, but quenched for fluorescence through physical mechanisms of looping the sequences or through other enzymatic means. Upon binding to the target sequences in the sample, these sequences will be exposed and the fluorescent dyes would be released for fluorescence emission. The method can also be used in multiplex detection of microorganisms. Different fluorescent spectra of microspheres conjugated with specific oligonucleotides on the surface of microspheres are incubated with an analyte sample to be tested. Each labeling reagent has a different Em spectrum. The signals are detected by multiple sensors, each detecting a specific wavelength.

Detection of Proteins, Biological Markers, and Metabolites

To detect proteins, biological markers, and metabolites, two reagents (Reagents A and B) are used. Reagent A is the same as the Reagent A as described above in the methods of Immunogenic Separation (IMS)/Fluorescent Microsphere. Reagent B is the same as the Reagent B as described above in the methods of Immunogenic Separation (IMS)/Fluorescent Particles. Reagents A and the sample are mixed and incubated. After about 10 minutes of incubation, the sample is washed one time with wash buffer (PBS-Tween20 (0.01%)) and then resuspended to a pre-warmed (37° C.) reaction buffer. Reagent B is added to the prepared sample. The samples are resuspended by pipeting up and down several times in an assay tube, which is then incubated at 37° C. for about 30 minutes with end-over rotation. After incubation, each assay tube is applied to the magnetic retriever for about 3 minutes and is washed twice with washing buffer, and then resuspended to a final volume of 1 ml of a detection buffer. It is then measured for protein concentrations.

High Throughput Automated Systems to Analyze Multiple Samples

Any of the above embodiments of the instrument in the present invention can further include a high throughput automated system to process and analyze multiple samples. Examples of the high throughput system include but are not limited to high throughput carousel systems and high throughput automated multiplex systems.

In a high throughput carousel system, the system comprises one or more racks, each rack holds multiple cuvettes or tubes containing the sample mixture. All the steps needed to prepare the sample to react with the various reagents, including liquid transfer, mixing, vortexing, applying magnetic force, moving of the cuvette from the rack to the cuvette holder in the instrument, etc. can fully be automated as part of the instrument or as an independent module working in conjunction with the instrument.

In a high throughput multiplex system, a deep well plate with multiple number of wells (e.g. from 8 to 384) is used as a multiplex platform. All steps necessary for the operation, including, for example, liquid handling, incubating, mixing, applying magnetic force, etc. can be fully automated either as part of the instrument or as an independent module working in conjunction with the instrument.

The present invention has many advantages over currently available analyte detection technologies, especially the detection of biological analytes such as cells, microorganisms, proteins, and nucleic acids or nucleic acid sequences.

### EXAMPLES

### Example 1

### Detection of Fluorescent Microspheres

The number of fluorescent peaks are counted and correlated to the concentration of fluorescent microspheres. The diameter of the microspheres is approximately 2.5 μm and it has a 630/640 nm Ex/Em spectrum. A cuvette containing diluted microspheres in a final volume of 4 ml of 0.1M PBS was then subjected to simultaneous vertical and rotational motions. The vertical and rotational speeds of the cuvette movement were 0.8 inch/sec and 300 rpm, respectively. Data was acquired at a sampling rate of 100 kHz for 2 minutes. Raw data was analyzed and the result was displayed as described previously in this application, which enumerated the number of fluorescent signals whose pulse width was between 0.05-0.2 milliseconds and pulse amplitude was greater than that of mean background plus 3 times of standard deviation (mean+3 SD).

The results are shown in FIG. 9. Five different sets of experiments were carried out in different days. The fluorescent signal counts were plotted against the concentration of fluorescent beads. As shown in FIG. 9, the counts from each concentration were very consistent even when the experiments were done at different times and days. The data not only indicate that the inherent variations among different experimental times, procedures, and experiment performers are minimal, but they also demonstrate that detection capability of the present instrument for fluorescent signals is consistent and reliable. This consistency and reliability over various experiments are also shown by high correlation between fluorescent count number and bead number as indicated by a high R² value of 0.9626. It shows that the present system is capable of detecting as low as 10 fluorescent beads/ml as well as a wide range of bead concentrations from 10/ml to 10⁵/ml. In this concentration range, the consistency and high correlation allow the evaluation of the extinction coefficient to enumerate the number of beads in a given sample.

### Example 2

### Detection of Salmonella by Using Polyclonal Antibodies Conjugated with Fluorescent Dyes in Phosphate Buffer

Salmonella typhimurium (ATCC #14028) was grown in 5 ml of LB media overnight at 37° C. The culture was washed and centrifuged in PBS buffer, pH 7.0 twice at 8,000×g for 10 minutes. The cell pellet was reconstituted to its original concentration in PBS. The overnight culture was close to the standard concentration of 5×10⁹ cells/ml. The overnight culture was diluted with 0.1 M PBS buffer to prepare a range of concentrations from 0 cell/ml to 10⁶ cells/ml in 1 ml total volume of PBST (0.1 M PBS, 0.01% Tween 20). A portion of each diluted culture was plated on S. typhimurium selective agar and incubated at 37° C. for overnight to verify actual colony forming unit (CFU).

In each samples, 100 μl (approximately 10⁵ beads, 0.86 μm in diameter) of magnetic microspheres coated with polyclonal antibodies for Salmonella was added followed by 30 minutes at room temperature with gentle rocking motions. The sample was placed in a magnetic retriever for 3 minutes, and the solution was decanted. This step was repeated twice. The final pellet was resuspended, and polyclonal antibodies conjugated with Alexa Fluor 633 for Salmonella (9 μg) was incubated for 30 minutes at room temperature in total volume of 1 ml PBST. The sample underwent the same washing step as described above before transferred to a cuvette. The measurement was taken at a rotational speed of 300 rpm and a vertical speed of 0.8 inch/sec at room temperature. The data were acquired at a sampling rate of 100 kHz for 30 sec. The raw data was analyzed as described previously in this application.

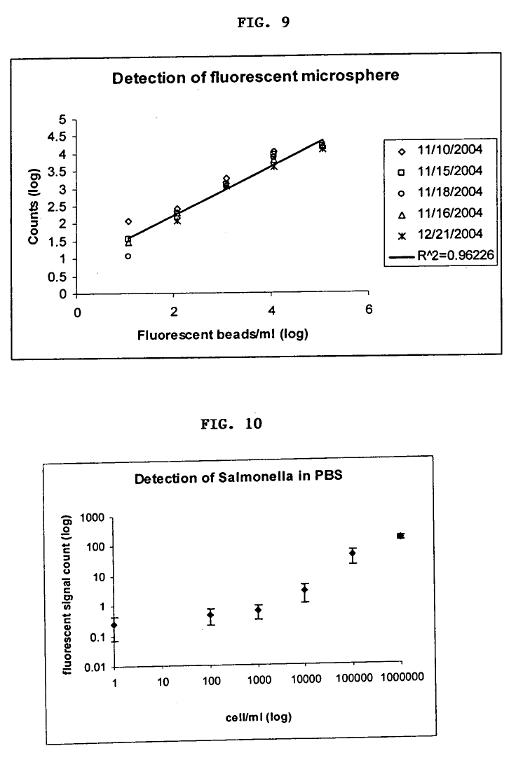

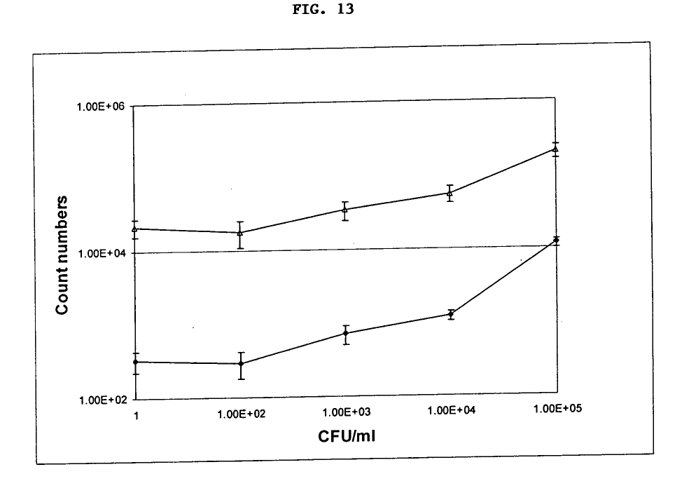

The result from one method is depicted in FIG. 10. Fluorescent signals whose pulse amplitude was greater than that of mean background+SD was counted in for each sample. Mean of fluorescent signal count of each concentration (from 0/ml to 10⁶ cells/ml) was plotted against CFU/ml (FIG. 12). Thirteen sets of assays were performed in different times. The signal count of samples above 10⁴ cells/ml were significantly higher than that of control that contained no cells (ANOVA p<0.01). It shows that the present system is capable of detecting Salmonella sp. within hours without enrichment when it is present at 10⁴ cells/ml or greater concentrations in biological samples. With further improvements in the reagent system and signal analysis programs, the sensitivity would increase to 10²-10³ cells/ml concentration detection capability.

### Example 3

### Detection of Salmonella by Using Polyclonal Antibodies Conjugated with Fluorescent Dyes in Ground Beef

By using Alexa Fluor conjugated polyclonal antibodies, S. typhimurium was detected in spiked ground beef. 25 g of ground beef was added into 225 ml of PBST in a sterile stomacher bag. After stomaching at 280 rpm for 2 minutes at room temperature, an aliquot of beef homogenate was spiked with S. typhimurium in a total volume of 1 ml of PBST. The samples were incubated with magnetic beads (approximately 10⁵ beads, 0.86 μm in diameter) coated with polyclonal antibodies for Salmonella sp. for 10 minutes at room temperature followed by 2 times of the washing step (2 minutes/each wash). The resulting pellet was resuspended with PBST and incubated with 9 μg of polyclonal antibodies for Salmonella conjugated with AlexaFluor 633 for 30 minutes at room temperature. The sample underwent the same washing step as described above before being transferred into a cuvette.

The measurement was taken at a cuvette rotational speed of 300 rpm and vertical speed of 0.8 inch/sec at room temperature. The data were acquired at a sampling rate of 100 kHz for 2 minutes. Raw data were analyzed as described previously in this application. It counted fluorescent signals whose pulse width was in between 0.05-0.2 millisecond and pulse amplitude was greater than that of mean background+3 SD. Each diluted samples was plated on antibiotic selective agar media overnight at 37° C. to verify the actual CFU/ml. Time consumed for the entire procedure was less than an hour.

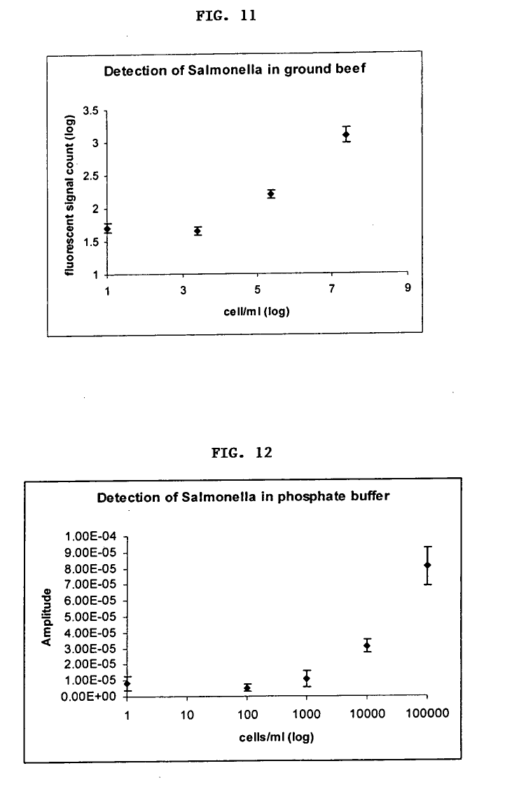

Mean of fluorescent signal count from each concentration (from 0/ml to 10⁷ cells/ml) was plotted against CFU/ml (FIG. 11). Four sets of assays were performed at different times. Similar correlation between fluorescent signal counts and CFU/ml was observed as previously shown as in detection of Salmonella in phosphate buffer. The signal count of samples above 10⁴ cells/ml were significantly higher than that of the control. And, high correlation between counts and CFU/ml is shown in a concentration range of 10⁴ cells/ml to 10⁷ cells/ml (R²=0.98). This data clearly shows that our system is capable of detecting Salmonella sp. within an hour when it is present in 10⁴ cells/ml or greater concentrations in ground beef.

### Example 4

### Detection of Salmonella sp. by Using Fluorescent Nanosphere in Phosphate Buffer

Nano-scale sized fluorescent beads were used to detect Salmonella typhimurium in phosphate buffer. Similar procedures, as described previously in Example 2, were employed except using a reagent of nanospheres In each sample, 3 μg of biotinylated polyclonal antibodies for Salmonella was incubated together with the magnetic beads. The same incubation and wash steps were followed as in Example 2. The final pellet was resuspended, and nanospheres conjugated polyclonal antibodies for Salmonella were incubated in the sample for 30 minutes at room temperature in total volume of 1 ml of PBST. The sample underwent the same washing step before being transferred into a cuvette. The measurement was taken at a cuvette rotational speed of 300 rpm and vertical speed of 0.8 inch/sec at room temperature. The data was acquired at a sampling rate of 100 kHz for 30 seconds. The raw data was analyzed by software of the present invention.

A result from Power Spectral Density (PSD) function is shown in FIG. 12. In FIG. 12, the amplitudes of low frequency signals were plotted against CFU/ml. It shows that the increase in amplitude of 10⁴/ml samples was highly significant compared to that of the control (ANOVA p<0.01, t-test p<0.01). Also, no false negatives wer observed in 10⁴ cells/ml samples (data not shown). The result does not only demonstrate that our system is capable of detecting Salmonella spp. when it is present at 10⁴ cells/ml and a greater concentration in biological samples within hours without enrichment, but it also shows improved detection capability of our system by using fluorescent nanospheres.

### Example 5

### Detection of Salmonella sp. by Using Fluorescent Beads in Pure Culture

Salmonella typhimurium (ATCC #14028) was grown in 5 ml of LB media overnight at 37° C. The culture was washed and centrifuged in PBS buffer twice at 8,000×g for 10 minutes. The cell pellet was reconstituted to its original concentration in PBS. The overnight culture was close to a concentration of 5×10⁹ cells/ml. The overnight culture was diluted with 0.1 M PBS buffer to prepare a range of concentrations from 0 cell/ml to 10⁵ cells/ml in 1 ml total volume of PBST (0.1 M PBS, 0.01% Tween 20).

Each 100 μl of the Reagents A and B, which are described in the Immunogenic Separation (IMS)/Fluorescent microsphere methods, was added simultaneously into the aliquoted bacteria sample. The sample mixture was incubated for 30 minutes at room temperature with gentle rocking motions to optimize antigen-antibody reaction. The sample tubes were placed in a magnetic retriever for 3 minutes, and the solution was decanted. The resulting pellet (bacteria-Reagent A, B complex) was resuspended with 1 ml PBST and transferred to a cuvette.

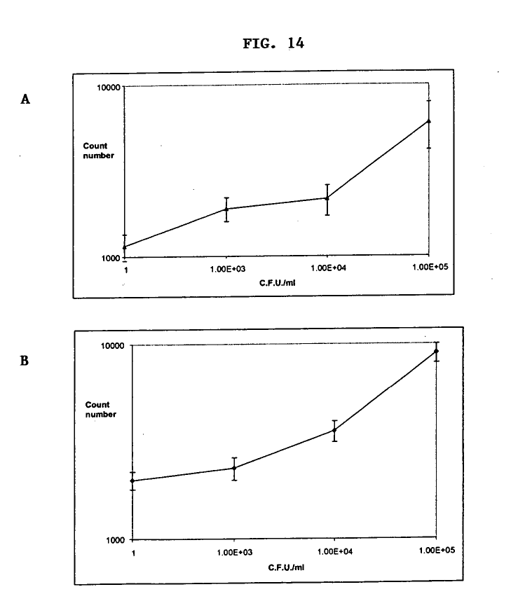

The measurement was taken at a rotational speed of 300 rpm and vertical speed of 0.8 inch/sec at room temperature. The data were acquired at a sampling rate of 100 kHz for 2 min. The raw data was analyzed by both the signal count method and weighted signal method, which are described in previous section. FIG. 13 shows the results from the signal count method (upper line) and the weighted count method (bottom line). The fluorescent signals, which have greater amplitude than that of mean background+3SD and pulse width in a range of 0.05-0.2 ms, were subjected to the count method and weighted method. As shown in FIG. 13, the signal count and weighted value of samples above 10⁴ cells/ml are significantly higher than that of control (no cell). The results show that the present invention is capable of detecting Salmonella spp. within an hour without enrichment when it is present in 10⁴ cells/ml or greater concentrations in phosphate buffer.

### Example 6

### Detection of Salmonella sp. by Using Fluorescent Beads in Food Samples (Ground Beef and Lettuce)

For the detection of Salmonella in a ground beef sample, ten grams of ground beef were transferred into a filtered stomacher bag with 280 μm pore size followed by addition of 90 ml of phosphate buffer. The sample was homogenized for 2 minutes at 230 rpm in the stomacher followed by low speed centrifugation to remove large food particles (100×g, 5 minutes). The resulting middle layer liquid sample was irradiated with UV light for 40 minutes to eliminate any indigenous Salmonella or other bacteria. The sterility of this meat juice sample was verified when plating on LB agar (without antibiotics), which resulted in no bacteria growth. Although this did not necessarily mean that all possible indigenous Salmonella that were irradiated would not react with antibody reagents as those may still have surface antigens available on intact membrane, there was no indication that indigenous Salmonella was present in the ground beef samples. The sterile meat juice sample was spiked with designated number of S. typhimurium. Similar procedures, as described in the previous example of detection of Salmonella ssp. by using fluorescent beads in pure culture (see Example 5), were employed.

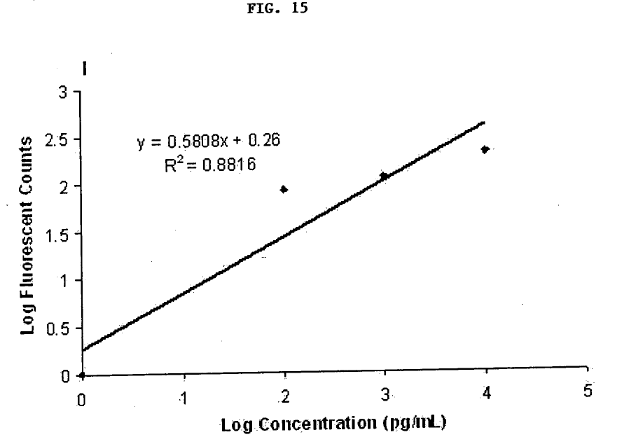

Raw data was analyzed, and the result was displayed which enumerated the number of fluorescent signals whose pulse width was between 0.05-0.2 ms and pulse amplitude was greater than that of mean background+3SD. In FIG. 14A, similar correlation between fluorescent signal counts and CFU/ml was observed as previously shown in phosphate buffer. The signal count of samples above 10⁴ cells/ml were significantly higher than that of the control. This data clearly shows that our system is capable of detecting Salmonella spp. within an hour when it is present in 10⁴ cells/ml or greater concentrations in ground beef.

For the detection of Salmonella in lettuce sample, 10 grams of lettuce were spiked with Salmonella and then transferred to a filtered stomacher bag with 280 μm pore size followed by addition of 50 ml PBS. The sample was homogenized in a stomacher for 2 minutes at 230 rpm. The stomacher bag was squeezed out by applying gentle force by hand to generate liquid sample. Since the lettuce sample did not generate as much food particles as meat samples, the liquid from the stomacher bag was not further processed by centrifugation. Similar procedures described in the previous example of detection of Salmonella sp. using fluorescent beads in pure culture (Example 5) were employed. Raw data was analyzed, and the result was displayed which enumerated the number of fluorescent signal whose pulse width was between 0.05-0.2 ms and pulse amplitude was greater than that of mean background+3SD. As shown in FIG. 14B, a low sensitivity level of 10⁴ cells/ml was attainable in this real food sample.

### Example 7

### Detection of BSA

Detection of Bovine Serum Albumin (BSA, MW 68 kD) (Ambion, Tex.), was performed as an example of the present invention to demonstrate the detection capability of protein molecules. Modified Anti-BSA polyclonal antibody (Biomeda) magnetic beads (Bang's Labs, IN) and an amount of BSA as used (10 ng, 1 ng, 0.1 ng, negative control) were mixed in a 1.5 ml tube to a volume of 200 μl. After 10 minutes of incubation, each tube of beads was washed one time with 500 μl of PBST and then resuspended to 100 μl with PBST. Pre-warmed (37° C.) PBS-T alone (negative control) or pre-warmed (37° C.) PBS-T containing the fluorescent dye labeled anti-BSA polyclonal antibodies (9 μg) was added to each tube for a final assay volume of 200 μl. Beads were resuspended by pipeting up and down several times and assay tube and were then incubated at 37° C. for 30 minutes with rotation. After the incubation, each tube was applied to a magnet for 3 minutes and washed twice with 500 μl of PBST, and then resuspended to a final volume of 1 ml PBST. Raw data was analyzed, and the result was displayed which enumerated the number of fluorescent signals whose pulse width was between 0.05-0.2 ms and pulse amplitude was greater than that of mean background+3SD. As shown in FIG. 15, a range of 10²-10⁴ pg/ml in 1 ml final volume correlated with fluorescent counts, demonstrating the sensitivity of our system and current limit of detection (LOD) of 0.1 ng/ml within a detection time of 25 minutes.

While specific embodiments have been illustrated and described, numerous modifications come to mind without departing from the spirit of the invention and the scope of protection is only limited by the scope of the accompanying claims.

### REFERENCES

1. Akane, A., K. Matsubara, H. Nakamura, S. Takahashi, and K. Kimura. 1994. Identification of the heme compound copurified with deoxyribonucleic acid (DNA) from bloodstains, a major inhibitor of polymerase chain reaction (PCR) amplification. J Forensic Sci 39:362-72.
2. Andersen, M. R., and C. J. Omiecinski. 1992. Direct extraction of bacterial plasmids from food for polymerase chain reaction amplification. Appl Environ Microbiol 58:4080-2.
3. Bieschke, J., A. Giese, W. Schulz-Schaeffer, I. Zerr, S. Poser, M. Eigen, and H. Kretzschmar. 2000. Ultrasensitive detection of pathological prions protein aggregates by dual-color scanning for intensely fluorescent targets. Proc Natl Acad Sci USA 97:5468-73.
4. Candish, A. A. G. 1991. Immunological methods in food microbiology. Food Microbiol. 8:1-14.
5. Che, Y. H., Y. Li, M. Slavik, and D. Paul. 2000. Rapid detection of Salmonella typhimurium in chicken carcass wash water using an immunoelectrochemical method. J Food Prot 63:1043-8.
6. 1 Chen, Y., J. D. Muller, K. M. Berland, and E. Gratton. 1999. Fluorescence fluctuation spectroscopy. Methods 19:234-52.
7. Coleman, D. J., K. J. Nye, K. E. Chick, and C. M. Gagg. 1995. A comparison of immunomagnetic separation plus enrichment with conventional Salmonella culture in the examination of raw sausages. Lett Appl Microbiol 21:249-51.
8. Cudjoe, K. S., R. Krona, and E. Olsen. 1994. IMS: a new selective enrichment technique for detection of Salmonella in foods. Int J Food Microbiol 23:159-65.
9. D'Aoust, J.-Y., A. M. Sewell, and P. Greco. 1991. Commercial latex agglutination kits for the detection of food-borne Salmonella. J. Food Prot. 54:725-730.
10. D'Haese, E., and H. J. Nelis. 2002. Rapid detection of single cell bacteria as a novel approach in food microbiology. J AOAC Int 85:979-83.
11. Donaghy, J. A., N. L. Totton, and M. T. Rowe. 2003. Evaluation of culture media for the recovery of Mycobacterium avium subsp. paratuberculosis from Cheddar cheese. Lett Appl Microbiol 37:285-91.
12. Dziezak, J. D. 1987. Rapid methods for microbiological analysis of food. Food Technol. 41:56-73.
13. Endo, H., J. Nakayama, H. Ushio, T. Hayashi, and E. Watanabe. 1998. Application of flow cytometry for rapid detection of Lactococcus garvieae. Appl Biochem Biotechnol 75:295-306.
14. Favrin, S. J., S. A. Jassim, and M. W. Griffiths. 2003. Application of a novel immunomagnetic separation-bacteriophage assay for the detection of Salmonella enteritidis and Escherichia coli O157:H7 in food. Int J Food Microbiol 85:63-71.
15. Feng, P. 2001. Development and impact of rapid methods for detection of food borne pathogens. ASM press, Washington D.C.
16. Feng, P. C., and P. A. Hartman. 1982. Fluorogenic assays for immediate confirmation of Escherichia coli. Appl Environ Microbiol 43:1320-9.
17. Fode-Vaughan, K. A., J. S. Maki, J. A. Benson, and M. L. Collins. 2003. Direct PCR detection of Escherichia coli O157:H7. Lett Appl Microbiol 37:239-43.
18. Gracias, K. S., and J. L. McKillip. 2004. A review of conventional detection and enumeration methods for pathogenic bacteria in food. Can J Microbiol 50:883-90.
19. Gratton, E., S. Breusegem, J. Sutin, Q. Ruan, and N. Barry. 2003. Fluorescence lifetime imaging for the two-photon microscope: time-domain and frequency-domain methods. J Biomed Opt 8:381-90.
20. Greer, G. G. 2005. Bacteriophage control of foodborne bacteriat. J Food Prot 68:1102-11.
21. Haustein, E., and P. Schwille. 2003. Ultrasensitive investigations of biological systems by fluorescence correlation spectroscopy. Methods 29:153-66.
22. Ingram, M., T. J. Cleary, B. J. Price, R. L. Price, 3rd, and A. Castro. 1982. Rapid detection of Legionella pneumophila by flow cytometry. Cytometry 3:134-7.
23. Johnson, P. E., M. L. Lund, R. W. Shorthill, J. E. Swanson, and J. L. Kellogg. 2001. Real time biodetection of individual pathogenic microorganisms in food and water. Biomed Sci Instrum 37:191-6.
24. Klingler, J. M., R. P. Stowe, D.C. Obenhuber, T. O. Groves, S. K. Mishra, and D. L. Pierson. 1992. Evaluation of the Biolog automated microbial identification system. Appl Environ Microbiol 58:2089-92.
25. Koseki, S., and S. Isobe. 2005. Growth of Listeria monocytogenes on iceberg lettuce and solid media. Int J Food Microbiol 101:217-25.
26. Kramer, M. F., and D. V. Lim. 2004. A rapid and automated fiber optic-based biosensor assay for the detection of Salmonella in spent irrigation water used in the sprouting of sprout seeds. J Food Prot 67:46-52.
27. Lappalainen, J., S. Loikkanen, M. Havana, M. Karp, A. M. Sjoberg, and G. Wirtanen. 2000. Microbial testing methods for detection of residual cleaning agents and disinfectants-prevention of ATP bioluminescence measurement errors in the food industry. J Food Prot 63:210-5.
28. Lee, J., and R. A. Deininger. 2004. Detection of E. coli in beach water within 1 hour using immunomagnetic separation and ATP bioluminescence. Luminescence 19:31-6.
29. Liu, Y., and Y. Li. 2002. Detection of Escherichia coli O157:H7 using immunomagnetic separation and absorbance measurement. J Microbiol Methods 51:369-77.
30. Lynch, M. J., C. G. Leon-Velarde, S. McEwen, and J. A. Odumeru. 2004. Evaluation of an automated immunomagnetic separation method for the rapid detection of Salmonella species in poultry environmental samples. J Microbiol Methods 58:285-8.
31. McKillip, J. L., L. A. Jaykus, and M. Drake. 2002. Influence of growth in a food medium on the detection of Escherichia coli O157:H7 by polymerase chain reaction. J Food Prot 65:1775-9.
32. Ninet, B., E. Bannerman, and J. Bille. 1992. Assessment of the Accuprobe Listeria monocytogenes culture identification reagent kit for rapid colony confirmation and its application in various enrichment broths. Appl Environ Microbiol 58:4055-9.
33. Notermans, S., and K. Wernars. 1991. Immunological methods for detection of foodborne pathogens and their toxins. Int J Food Microbiol 12:91-102.
34. Oehlenschlager, F., P. Schwille, and M. Eigen. 1996. Detection of HIV-1 RNA by nucleic acid sequence-based amplification combined with fluorescence correlation spectroscopy. Proc Natl Acad Sci USA 93:12811-6.
35. Radke, S. M., and E. C. Alocilja. 2005. A high density microelectrode array biosensor for detection of E. coli O157:H7. Biosens Bioelectron 20:1662-7.
36. Rossen, L., P. Norskov, K. Holmstrom, and 0. F. Rasmussen. 1992. Inhibition of PCR by components of food samples, microbial diagnostic assays and DNA-extraction solutions. Int J Food Microbiol 17:37-45.
37. Stender, H., A. Sage, K. Oliveira, A. J. Broomer, B. Young, and J. Coull. 2001. Combination of ATP-bioluminescence and PNA probes allows rapid total counts and identification of specific microorganisms in mixed populations. J Microbiol Methods 46:69-75.
38. Tortorello, M. L., D. S. Stewart, and W. C. Cray, Jr. 1996. Rapid identification of Escherichia coli O157:H7 in bovine feces using the antibody-direct epifluorescent filter technique (Ab-DEFT). Vet Microbiol 51:343-9.
39. Vaneechoutte, M., and J. Van Eldere. 1997. The possibilities and limitations of nucleic acid amplification technology in diagnostic microbiology. J Med Microbiol 46:188-94.
40. Walter, N. G., P. Schwille, and M. Eigen. 1996. Fluorescence correlation analysis of probe diffusion simplifies quantitative pathogen detection by PCR. Proc Natl Acad Sci USA 93:12805-10.
41. Wang, X., and M. F. Slavik. 1999. Rapid detection of Salmonella in chicken washes by immunomagnetic separation and flow cytometry. J Food Prot 62:717-23.
42. Warburton, D. W., P. T. Feldsine, and M. T. Falbo-Nelson. 1995. Modified immunodiffusion method for detection of Salmonella in raw flesh and highly contaminated foods: collaborative study. J. AOAC Int. 78:59-68.
43. Yamaguchi, N., M. Sasada, M. Yamanaka, and M. Nasu. 2003. Rapid detection of respiring Escherichia coli O157:H7 in apple juice, milk, and ground beef by flow cytometry. Cytometry A 54:27-35.

What is claimed is:

1. A method for real time, rapid detection of a target analyte in a complex sample comprising:
(a) providing the sample in a liquid medium having a first volume;
(b) capturing and isolating the target analyte from the sample;
(c) mixing the captured and isolated target analyte with a ligand labeled with a fluorescent marker to form a sample mixture, wherein the ligand is capable of binding to the target analyte;
(d) scanning a volume of the sample mixing over a period of scanning time with an excitation light having a wavelength capable of exciting the fluorescent marker to emit an emission light from the sample mixture, wherein the scanning is not repeated with any given volume of the sample mixture;
(e) recording the intensity of the emission light over the period of scanning time as a multitude of signal peaks; and
(f) calculating the number of target anlaytes in the scanned volume of the sample from the recorded signal peaks.

2. The method of claim 1, wherein the scanning a volume of the sample mixture is accomplished by simultaneously providing the sample mixture with a rotational motion at a rotational speed and a vertical inversion motion at a vertical speed, wherein the rotational speed is greater than the vertical speed, and the volume scanned is proportional to the period of time of scanning.

3. The method of claim 2, wherein the scanning a volume of the sample mixture is accomplished by providing the sample mixture with a sideway motion.

4. The method of claim 1, wherein the intensity of the emission light is recorded with a photo sensor selected from the group consisting of: a photo-multiplier tube (PMT), an avalanche photodiode (ADP), and a charge-coupled device (CCD).

5. The method of claim 1, wherein the excitation light is laser beam generated by a laser.

6. The method of claim 5, wherein the laser is a light emitting diode (LED) laser.

7. The method of claim 1, wherein the target analyte is selected from the group consisting of: cells, microorganisms, organelles, viruses, proteins, nucleic acids, nucleic acid sequences, prions, and chemical, metabolic, or biological markers.

8. The method of claim 1 wherein the target analyte is a microorganism and the method detects a very low number of the microorganism without an enrichment step.

9. The method of claim 1, wherein the target analyte is a nucleic acid sequence and the method detects a very lower level of the sequence without an amplification step.

10. The method of claim 1, wherein the target analyte is a DNA of a live cell or a dead cell.

11. The method of claim 1, wherein the target analyte is a microorganism.

12. The method of claim 11, wherein the microorganism is pathogenic.

13. The method of claim 1, wherein the target analyte is a food-borne pathogen.

14. The method of claim 13, wherein the food-borne pathogen is selected from the group consisting of: Salmonella sp., Listeria sp., Campylobacte sp., Staphylococcus sp., Vibrio sp., Yersinia sp., Clostridium sp., Bacillus sp., Alicyclobacillus sp. Lactobacillus sp., Aeromonas sp., Shigella sp., Streptococcus sp, E. coli, Giardia sp., Entamoeba sp., Cryptosporidium sp., Anisakis sp., Diphyllobothrium sp., Nanophyetus sp., Eustrongylides sp., Acanthamoeba sp., and Ascaris ssp. and enteric bacteria;

15. The method of claim 1, wherein the ligand is selected from the group consisting of: monoclonal antibodies, polyclonal antibodies, soluble receptors, oligonucleotide probes and nucleic acid sequences.

16. The method of claim 12, wherein the microorganism is a clinical pathogen.

17. The method of claim 7, wherein the virus is selected from the group consisting of Norovirus, Rotavirus, Hepatitis virus, Herpes virus, and HIV virus, and Parvovirus.

18. The method of claim 7, wherein the protein is a toxin.

19. The method of claim 18, wherein the toxin is selected from the group consisting of Aflatoxins, Enterotoxin, Ciguatera poisoning, Shellfish toxins, Scombroid poisoning, Tetroditoxin, Pyrrolizidine alkaloids, Mushroom toxins, Phytohaemagglutinin, and Grayanotoxin.

20. The method of claim 7, wherein the metabolite is protein, lipid, carbohydrate or peptide.

21. The method of claim 1, wherein the sample is selected from the group consisting of a food sample, a clinical sample and an environmental sample.

22. The method of claim 1, wherein the detection is selected from the group consisting of: identifying, quantifying, enumerating and a combination thereof.

23. The method of claim 1 further comprising a concentration step after capturing and isolating the analyte by reconstituting the sample in a second volume wherein the second volume is less than the first volume.

24. The method of claim 1, wherein the capturing and isolating of the analyte is accomplished by immunomagnetic separation comprising
(a) coating a magnetic particle with a ligand to form a ligand-magnetic particle complex wherein the ligand is capable of binding to the analyte;
(b) mixing the ligand-magnetic particle complex with the sample in the liquid medium to form an analyte-ligand-magnetic particle complex in suspension; and
(c) subjecting the suspension to a magnetic force to separate the analyte-ligand-magnetic particle complex from the sample in the liquid medium followed by removing the liquid medium with the sample.

25. The method of claim 24, wherein the ligand is selected from the group consisting of: monoclonal antibodies, polyclonal antibodies, soluble receptors, oligonucleotide probes and nucleic acid sequences.

26. The method of claim 25, wherein the magnetic particle is a bead, a microsphere, or a nanosphere.

27. The method of claim 1, wherein the steps (b) and (c) are conducted simultaneously.

28. The method of claim 1, wherein the fluorescent marker is selected from the group consisting of: fluorescent dye, fluorescent beads, fluorescent microsphere, fluorescent nanosphere, and nano quantum dot.

29. The method of claim 1 further comprising a washing step between step (c) and step (d).

30. The method of claim 1, wherein the target analyte is a cell, and the method detects total viable cell counts in the sample.
